(19) United States
(12) Patent Application Publication
(10) Pub. No.: US 2025/0261150 A1
(43) Pub. Date: Aug. 14, 2025

(54) APPARATUS AND METHOD FOR PROVIDING USER PLANE FUNCTION FUNTIONALITIES IN WIRELESS COMMUNICATION SYSTEM

(71) Applicant: ELECTRONICS AND TELECOMMUNICATIONS RESEARCH INSTITUTE, Daejeon (KR)

(72) Inventors: Seung Han CHOI, Daejeon (KR); Namseok KO, Daejeon (KR)

(73) Assignee: ELECTRONICS AND TELECOMMUNICATIONS RESEARCH INSTITUTE, Daejeon (KR)

(21) Appl. No.: 19/051,977

(22) Filed: Feb. 12, 2025

(30) Foreign Application Priority Data
Feb. 14, 2024 (KR) 10-2024-0021246
Feb. 22, 2024 (KR) 10-2024-0025593
Mar. 7, 2024 (KR) 10-2024-0032462
Aug. 1, 2024 (KR) 10-2024-0102667
Aug. 8, 2024 (KR) 10-2024-0105821
Jan. 17, 2025 (KR) 10-2025-0007024

(51) Int. Cl. H04W 60/04; H04L 43/028; H04L 43/065; H04W 28/06

(52) U.S. Cl. CPC H04W 60/04; H04L 43/028; H04L 43/065; H04W 28/06

(57) ABSTRACT

The present disclosure relates generally to wireless communication systems, and more specifically to apparatus and method for providing User Plane Function (UPF) functionality in a wireless communication system. A method of providing user plane function (UPF) functionality information in a wireless communication system may include registering, by a first network function, the UPF functionality information including a packet inspection functionality to a network repository function (NRF); and searching, by a second network function, the NRF for the UPF including the packet inspection functionality.

### CROSS REFERENCE TO RELATED APPLICATION

The present application claims priority to Korean Patent Application No. 10-2024-0021246, filed Feb. 14 2024, Korean Patent Application No. 10-2024-0025593, filed Feb. 22, 2024, Korean Patent Application No. 10-2024-0032462, filed March 07,2024, Korean Patent Application No. 10-2024-0102667, filed Aug. 1, 2024, Korean Patent Application No. 10-2024-0105821, filed Aug. 8, 2024, and Korean Patent Application No. 10-2025-0007024, filed Jan. 17, 2025, the entire contents of which is incorporated herein for all purposes by this reference.

### BACKGROUND OF THE INVENTION

### Field of the Invention

The present disclosure relates generally to wireless communication systems and, more specifically, to apparatus and method for providing User Plane Function (UPF) functionality in a wireless communication system.

### Description of the Related Art

The 3GPP 5G system aims to provide functions such as packet routing, data forwarding, and Quality of Service (QoS) management, in the data processing layer through a User Plane Function (UPF) that connects a radio access network (RAN) and a data network (DN).

The wireless communications market requires packet inspection functionality capable of supporting services, such as application and subscriber-based routing policies, QoS management through application-based prioritization and optimization policies, detection of malicious and malicious activities and abuse of network resources, and artificial intelligence (AI)-based network slicing automation, in addition to simple packet forwarding roles.

In the current 3GPP Rel-16/17/18, it is not defined how SMFs and other NFs search UPFs with packet inspection functionality. In addition, it does not define procedures for parameter provisioning of a Graphics Processing Unit (GPU), a Data Processing Unit (DPU), a Firewall, Distributed Denial of Service (DDoS) protection, and Deep Packet Inspection (DPI) features to improve the performance and security of UPFs. The GPU may provide performance which is excellent for large-scale data processing and AI/ML tasks, and the DPU may offload high-performance network functions and support network acceleration.

In addition, in order to realize extended Reality and Media service (XRM) services including Virtual Reality (VR), Augmented Reality (AR), and Mixed Reality (MR) in mobile communication networks, related technologies are being implemented and standardization work for interoperability is in progress. However, in the current 3GPP Rel-16/17/18/19, the method of finding session management function (SMF), Policy Control Function (PCF), and UPF with Media over QUIC (MoQ) traffic Relay support function, Connect-UDP (User Diagram Protocol) support feature, and HTTP/3 (Hypertext Transfer Protocol/3) support feature is not defined. These functions are essential elements for providing XRM services efficiently.

In addition, as sensing technology using millimeter waves and beamforming technology is combined with communications in the cellular system of mobile communication networks, a problem of data network congestion due to the increase in sensing information traffic is expected. Although there is a need for a functionality to store sensing information traffic in the UPF according to its importance to solve the problem, a method of finding a UPF with sensing information storage features by a SMF and other Network Functions (NFs) is not defined.

### SUMMARY OF THE INVENTION

Based on the foregoing, an objective of the present invention is to provide an apparatus and a method that enables a User Plane Function (UPF) having packet inspection functionality to be registered to a Network Repository Function (NRF), and to be searched by a Session Management Function (SMF) and another NF (Network Function) in a wireless communication system.

In addition, the present disclosure provides an apparatus and method for providing a procedure for parameter provisioning between Application Function (AF)/Network Exposure Function (NEF)/Unified Data Management (UDM)/SMF/UPF or Operation Administration Maintenance (OAM)/NRF/SMF/UPF for parameter provisioning of Graphics Processing Unit (GPU), Data Processing Unit (DPU), firewall, Distributed Denial of Service (DDoS) protection, and Deep Packet Inspection (DPI) features on the UPF in a wireless communication system.

In addition, the present disclosure provides an apparatus and method for allowing a UPF having GPU, DPU, firewall, DDoS protection, and DPI support features to be registered to an NRF and to be searched for by an SMF and another NF in a wireless communication system.

In addition, the present disclosure provides an apparatus and method for allowing an SMF, a Policy Control Function (PCF), and a UPF having a Media over QUIC (MoQ) traffic Relay support function, a Connect-UDP (User Datagram Protocol) support feature, and an HTTP/3 (Hypertext Transfer Protocol/3) support feature to be registered to an NRF, and to be searched for by another NF in a wireless communication system.

In addition, the present disclosure provides an apparatus and method for allowing a UPF with a sensing information storage feature to be registered to an NRF, and to be searched for by an SMF and another NF in a wireless communication system.

According to various embodiment of the present disclosure, a method of providing user plane function (UPF) functionality information in a wireless communication system may include registering, by a first network function, the UPF functionality information including a packet inspection functionality to a network repository function (NRF); and searching, by a second network function, the NRF for the UPF including the packet inspection functionality, wherein the registering of the UPF functionality information to the NRF comprises registering the UPF functionality information supporting a packet inspection functionality through a service based interface (SBI), and containing a packet inspection Feature (packet inspection in a UP function, PINU) in the UPF functionality information; and the searching for the UPF comprises transmitting a search request through the SBI, and containing search parameters including the packet inspection Feature (PINU) in the search request.

According to various embodiment of the present disclosure, an apparatus for providing User Plane Function (UPF) function information in a wireless communication system may include a transceiver; and a processor operably connected to the transceiver, wherein the processor performs control so that a first network function registers UPF functionality information including a packet inspection functionality to a Network Repository Function (NRF), and performs control so that a second network function searches the NRF for the UPF including the packet inspection functionality, and the processor registers the UPF functionality information supporting packet inspection functionality through a Service Based Interface (SBI) and contains a packet inspection Feature (Packet Inspection in the UP function, PINU) in the UPF functionality information, to register the UPF functionality information to the NRF, and transmits a search request through the SBI, and contains a search parameter with the packet inspection Feature (PINU) in the search request, to search for the UPF.

According to various embodiment of the present disclosure, a method of providing User Plane Function (UPF) function information in a wireless communication system may include performing, by a Session Management Function (SMF), an Association Setup procedure with the UPF through an N4 interface; checking, by the UPF, whether a Packet Inspection Feature (PINU) is contained in the UP Function Features; and receiving, by the SMF, a response regarding whether the Packet Inspection Feature (PINU) is supported from the UPF.

According to various embodiments of the present disclosure, an apparatus for providing a User Plane Function (UPF) functionality information in a wireless communication system includes a transceiver; and a processor operably connected to the transceiver, wherein the processor may perform control in such a manner as to perform an Association Setup procedure with the UPF through an N4 interface, determine whether the UPF contains a Packet Inspection in the UP function (PINU) in the UP Function Features, and receive a response from the UPF regarding whether the Packet Inspection Feature (PINU) is supported.

The apparatus and method according to various embodiments of the present disclosure can allow a User Plane Function (UPF) to register a packet inspection feature, and Graphics Processing Unit (GPU), Data Processing Unit (DPU), Firewall, Distributed Denial of Service (DDoS) protection, and Deep Packet Inspection (DPI) support features to a Network Repository Function (NRF), to be searched for by a Session Management Function (SMF) and other Network Functions (NFs), thereby making it possible to efficiently provide network functions and security functions of high-performance in a 5G system.

In addition, the apparatus and method according to various embodiments of the present disclosure can allow a UPF to register a Media over QUIC (MoQ) traffic Relay support function, a Connect-User Datagram Protocol (UDP) support feature, a Hypertext Transfer Protocol/3 (HTTP/3) support feature, and a sensing information storage feature to the NRF, to be searched for, thereby making it possible to stably provide extended Reality and Media service (XRM) service and sensing-based service.

The effects obtainable from the present disclosure are not limited to the effects mentioned above, and other effects not mentioned may be clearly understood by a person having ordinary knowledge in the technical field to which the present disclosure belongs from the description below.

### BRIEF DESCRIPTION OF THE DRAWINGS

FIG. 1 illustrates a 3GPP 5G system architecture of a service-based architecture, according to various embodiments of the present disclosure.

FIG. 2A illustrates a procedure in which a UPF register its function to an NRF, according to various embodiments of the present disclosure.

FIG. 2B illustrates detailed attributes of NFProfile information that a UPF registers with an NRF, according to various embodiments of the present disclosure.

FIG. 2C illustrates detailed attributes of UpfInfo that a UPF registers with an NRF, according to various embodiments of the present disclosure.

FIG. 2D illustrates a procedure in which an NF Service Consumer searches an NRF for a UPF with a specific function, according to various embodiments of the present disclosure.

FIG. 3 illustrates details of UP Function Features defined in 3GPP TS 29.244 Table 8.2.25-1, according to various embodiments of the present disclosure.

FIG. 4 illustrates an Association Setup procedure performed through an N4 interface between a Session Management Function (SMF) and a User Plane Function (UPF), according to various embodiments of the present disclosure.

FIG. 5 illustrates provisioning parameters included in a Nnef ParameterProvison service operation, according to various embodiments of the present disclosure.

FIG. 6 illustrates a parameter provisioning procedure by an Application Function (AF), according to various embodiments of the present disclosure.

FIG. 7 illustrates a parameter provisioning procedure by a Network Repository Function (NRF), according to various embodiments of the present disclosure.

FIG. 8A illustrates a procedure in which a Session Management Function (SMF) registers its function to a Network Repository Function (NRF), according to various embodiments of the present disclosure.

FIG. 8B illustrates detailed attributes of NFProfile information that an SMF registers with an NRF, according to various embodiments of the present disclosure.

FIG. 8C illustrates detailed attributes of smfInfo that an SMF registers with an NRF, according to various embodiments of the present disclosure.

FIG. 8D illustrates a procedure in which another NF searches a Network Repository Function (NRF) for a Session Management Function (SMF) with a specific function, according to various embodiments of the present disclosure.

FIG. 9A illustrates a procedure in which a Policy Control Function n (PCF) registers its function to an NRF (Network Repository Function), according to various embodiments of the present disclosure.

FIG. 9B illustrates detailed attributes of NFProfile information that a PCF registers with an NRF, according to various embodiments of the present disclosure.

FIG. 9C illustrates detailed attributes of pcfInfo that a PCF registers with an NRF, according to various embodiments of the present disclosure.

FIG. 9D illustrates a procedure in which an NF Service Consumer searches an NRF for a PCF with a specific function, according to various embodiments of the present disclosure.

FIG. 10 illustrates UP Function Features including a packet inspection feature for a UPF of a 5G system to provide UP Function Features information to an NRF or an SMF, according to an embodiment of the present disclosure.

FIG. 11 illustrates a procedure in which a UPF including a packet inspection feature (PINU) registers with an NRF, according to an embodiment of the present disclosure.

FIG. 12 illustrates a procedure in which an NF Service Consumer searches a NRF for a UPF containing a packet inspection feature (PINU), according to an embodiment of the present disclosure.

FIG. 13 illustrates a procedure in which a UPF provides UP Function Features including a packet inspection feature (PINU) to an SMF in an Association Setup procedure of an SMF and a UPF, according to an embodiment of the present disclosure.

FIG. 14 illustrates provisioning parameters included in an Nnef ParameterProvison service operation, according to an embodiment of the present disclosure.

FIG. 15 illustrates detailed provisioning parameters for GPU configuration by category, according to an embodiment of the present disclosure.

FIG. 16 illustrates detailed provisioning parameters for DPU configuration by category, according to an embodiment of the present disclosure.

FIG. 17 illustrates detailed provisioning parameters for firewall configuration by category, according to an embodiment of the present disclosure.

FIG. 18 illustrates detailed provisioning parameters for Distributed Denial of Service (DDoS) protection configuration by category, according to an embodiment of the present disclosure.

FIG. 19 illustrates detailed provisioning parameters for DPI configuration by category, according to an embodiment of the present disclosure.

FIG. 20 illustrates a parameter provisioning procedure by an AF including GPU, DPU, firewall, DDoS protection, and DPI configuration parameters, according to an embodiment of the present disclosure.

FIG. 21 illustrates provisioning parameters included in an Nnrf NFManagement service operation, according to an embodiment of the present disclosure.

FIG. 22 illustrates a parameter provisioning procedure by an NRF, according to an embodiment of the present disclosure.

FIG. 23 illustrates detailed attributes of upfInfo that UPF registers with an NRF, according to an embodiment of the present disclosure.

FIG. 24 illustrates a form in which new functions are added to existing UP Function Features, according to an embodiment of the present disclosure.

FIG. 25 illustrates a procedure in which a UPF registers GPU, DPU, firewall, and DDoS protection support features to an NRF, according to an embodiment of the present disclosure.

FIG. 26 illustrates a procedure in which an NF Service Consumer searches an NRF for a UPF with GPU support feature, according to an embodiment of the present disclosure.

FIG. 27 illustrates an Association Setup procedure of SMF and UPF, according to an embodiment of the present disclosure.

FIG. 28 illustrates detailed attributes of MoQ traffic Relay support function, Connect-UDP support function, and HTTP/3 support function included in smfInfo that SMF registers with NRF, according to an embodiment of the present disclosure.

FIG. 29 illustrates a procedure in which SMF including MoQ traffic Relay support function, Connect-UDP support function, and HTTP/3 support function registers with NRF, according to an embodiment of the present disclosure.

FIG. 30 illustrates a procedure in which an NF Service Consumer searches an NRF for an SMF having a MoQ traffic Relay support function, according to an embodiment of the present disclosure.

FIG. 31 illustrates detailed attributes of a MoQ traffic Relay support function, a Connect-UDP support function, and an HTTP/3 support function included in pcfInfo that a PCF registers with an NRF, according to an embodiment of the present disclosure.

FIG. 32 illustrates a procedure in which a PCF including a MoQ traffic Relay support function, a Connect-UDP support function, and an HTTP/3 support function registers with an NRF, according to an embodiment of the present disclosure.

FIG. 33 illustrates a procedure in which an NF Service Consumer searches a PCF with a MoQ traffic Relay support function in an NRF, according to an embodiment of the present disclosure.

FIG. 34 illustrates detailed attributes of a MoQ traffic Relay support function, a Connect-UDP support function, and an HTTP/3 support function included in upfInfo that a UPF registers with an NRF, according to an embodiment of the present disclosure.

FIG. 35 illustrates UP Function Features including MoQ traffic Relay support function, Connect-UDP support function, and HTTP/3 support function Feature included in supportedPfcpFeatures of FIG. 34, according to an embodiment of the present disclosure.

FIG. 36 illustrates a procedure in which a UPF including MoQ traffic Relay support function, Connect-UDP support function, and HTTP/3 support function registers with NRF, according to an embodiment of the present disclosure.

FIG. 37 illustrates a procedure in which an NF Service Consumer searches a UPF with a MoQ traffic Relay support function in an NRF, according to an embodiment of the present disclosure.

FIG. 38 illustrates a procedure in which an UPF provides UP Function Features including a MoQ traffic Relay support function, a Connect-UDP support function, and an HTTP/3 support function Features to an SMF in an Association Setup procedure of an SMF and a UPF, according to an embodiment of the present disclosure.

FIG. 39 illustrates a table in which a sensing information storage Feature is added into existing UP Function Features, according to an embodiment of the present disclosure.

FIG. 40 illustrates a procedure in which an UPF including a sensing information storage Feature registers with an NRF, according to an embodiment of the present disclosure.

FIG. 41 illustrates a procedure in which an NF Service Consumer searches an NRF for a UPF having a sensing information storage feature, according to an embodiment of the present disclosure.

FIG. 42 illustrates a procedure in which a UPF provides UP Function Features including a sensing information storage feature to an SMF in an Association Setup procedure of an SMF and a UPF, according to an embodiment of the present disclosure.

FIG. 43 illustrates a configuration of a network entity in a wireless communication system, according to various embodiments of the present disclosure.

FIG. 44 illustrates a configuration diagram of a terminal in a wireless communication system, according to various embodiments of the present disclosure.

### DETAILED DESCRIPTION OF THE INVENTION

The terms used herein are used only to describe specific embodiments and may not be intended to limit the scope of other embodiments. A singular expression may include plural expressions unless the context clearly indicates otherwise. Terms used herein, including technical or scientific terms, may have the same meaning as commonly understood by a person of ordinary skill in the art described in this disclosure. Terms defined in general dictionaries among the terms used herein may be interpreted as having the same or similar meaning as the meaning they have in the context of the relevant technology, and shall not be interpreted in an ideal or excessively formal meaning unless explicitly defined in this disclosure. In some cases, even when a term is defined in this disclosure, it cannot be interpreted to exclude embodiments of this disclosure.

The various embodiments of the present disclosure described below are described by way of example using a hardware-based approach. However, since the various embodiments of the present disclosure include techniques using both hardware and software, the various embodiments of the present disclosure do not exclude a software-based approach.

In addition, in the detailed description and claims of the present disclosure, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

The present disclosure relates to an apparatus and method for providing UPF functionalities in a wireless communication system. Specifically, the present disclosure describes a technology for allowing a UPF having a packet inspection feature, and Graphics Processing Unit (GPU), Data Processing Unit (DPU), firewall, Distributed Denial of Service (DDoS) protection, and

Deep Packet Inspection (DPI) features to be registered to a Network Repository Function (NRF) and to be searched for, and a technology for supporting extended Reality and Media service (XRM) service and storing sensing information.

Terms referring to signals, terms referring to channels, terms referring to control information, terms referring to network entities, terms referring to components of apparatus, etc., which are used in the following, are used for convenience of explanation. Therefore, the present disclosure is not limited to the terms described below, and other terms having equivalent technical meanings may be used.

In addition, although the present disclosure describes various embodiments using terms used in some communication standards (e.g., 3rd Generation Partnership Project (3GPP)), these are only examples for the purpose of explanation. The various embodiments of the present disclosure may be easily modified and applied in other communication systems.

The present disclosure relates to a method of providing User Plane Function (UPF) functionalities in a 3GPP 5G system, and specifically, a method of allowing a User Plane Function (UPF) having a packet inspection functionality resister with a Network Repository Function (NRF), and a method of allowing a Session Management Function (SMF) and a UPF with a packet inspection functionality to perform an Association Setup procedure.

The present disclosure relates to a method of provisioning parameters of Graphics Procession Unit (GPU), Data Procession Unit firewall, Distributed Denial of Service (DDoS) protection, and Deep Packet Inspection (DPI) support features in User Plane Function (UPF) which is a Network Function (NF) in a 3GPP 5G system and, specifically relates to a procedure for parameter provisioning between AF (Application Function)/NEF (Network Exposure Function)/UDM (Unified Data Management Function)/SMF (Session Management Function)/UPF for provisioning of parameters of Graphics Processing Unit (GPU), Data Processing Unit (DPU), Firewall, Distributed Denial of Service (DDoS) Protection, Deep Packet Inspection (DPI), a procedure for parameter provisioning between Operation Administration Maintenance (OAM)/(Network Repository Function (NRF)/Session Management Function (SMF)/UPF, a method of allowing a UPF with GPU, DPU, firewall, DDoS Protection, DPI support features to be registered to a Network Repository Function (NRF), a method of allowing other NF to search for the UPF with GPU, DPU, firewall, DDoS Protection, DPI support features through the NRF, and a method of allowing the SMF and the UPF with GPU, DPU, firewall, DDoS protection, and DPI support features to perform an Association Setup Procedure.

The present disclosure relates to a method of providing Extended Reality and Media service (XRM) support features of Session Management Function (SMF), User Plane Function (UPF), and Policy Control Function (PCF), which are Network Functions (NFs) of a 3GPP 5G system and, specifically relates a method of allowing SMF, UPF, and PCF with XRM-related Media over QUIC (MoQ) traffic Relay support function, Connect-UDP (User Datagram Protocol) support feature, and HTTP (Hypertext Transfer Protocol)/3 support feature to be registered to a Network Repository Function (NRF), a method of allowing another NF to search for SMF, UPF, and PCF with Media over QUIC (MOQ) traffic Relay support function, Connect-User Diagram Protocol (UDP) support feature, and Hypertext Transfer Protocol/3 (HTTP/3) support feature through NRF, and a method of allowing a SMF and a UDP with MoQ traffic Relay support function, Connect-UDP support function, and HTTP/3 support function to perform an Association Setup procedure.

The present disclosure relates to a method of providing User Plane Function (UPF) functionalities in a 3GPP 5G system and, specifically to a method of allowing a User Plane Function (UPF) with a sensing information storage feature to be registered to a Network Repository Function (NRF), and a method of allowing a Session Management Function (SMF) and the UPF with the sensing information storage feature to perform an Association Setup procedure.

This present disclosure is to propose a method of allowing a UPF with a packet inspection functionality in a 5G system to be registered to an NRF, and a method of allowing the UPF with the packet inspection functionality and an SMF to perform an Association Setup procedure.

This present disclosure is to propose a method of performing parameter provisioning between AF/NEF/UDM/SMF/UPF or between OAM/NRF/SMF/UPF, for parameter provisioning of GPU, DPU, firewall, DDoS protection, and DPI features of UPF in a 5G system, a method of allowing the UPF with GPU, DPU, firewall, DDoS protection, and DPI support features to be registered to the NRF so that other NFs may search for the UPF with GPU, DPU, firewall, DDoS protection, and DPI support features, and a method of allowing the SMF and the UPF with GPU, DPU, firewall, DDoS protection, and DPI support features to perform an Association Setup procedure.

The present disclosure is to propose a method of allowing an SMF, a PCF, and a UPF with MoQ traffic Relay support function, Connect-UDP support function, and HTTP/3 support function to be registered to an NRF in a 5G system, and a method of allowing the SMF and the UPF with MoQ traffic Relay support function, Connect-UDP support function, and HTTP/3 support function to perform an Association Setup procedure, so that other NEs may find the SMF, the PCF, and the UPF with a MoQ traffic Relay support function, a Connect-UDP support function, and a HTTP/3 support function. The present disclosure is to propose a method of allowing a UPF with a sensing information storage feature to be registered to an NRF in a 5G system, and a method of allowing a UPF with a sensing information storage feature to perform an association setup procedure along with an SMF.

FIG. 1 illustrates a 3GPP 5G system architecture of a service-based architecture, according to various embodiments of the present disclosure.

Referring to FIG. 1, an upper layer may include Network Slice Selection Function (NSSF), Network Exposure Function (NEF), Network Repository Function (NRF), Policy Control Function (PCF), Unified Data Management (UDM), Application Function (AF), and EASDE, in which they are connected to the service-based architecture through Nnsf, Nnef, Nnrf, Npcf, Nudm, Naf, and Neasdf interfaces, respectively.

A middle layer includes NSSF, Authentication Server Function (AUSF), Access and Mobility Management Function (AMF), Session Management Function (SMF), and NSACF, which are connected through Nnssi, Nausf, Namf, Nsmf, and Nnsacf interfaces, respectively. A lower layer includes User Equipment (UE), Radio Access Network ((R)AN), User Plane Function (UPF), and Data Network (DN). The UE is connected to (R)AN through an N1 interface, and (R)AN is connected to AMF through an N2 interface, and UPF through an N3 interface. The SMF is connected to UPF through an N4 interface, and UPF is connected to DN through N6 interfaces.

In particular, the present disclosure has the significant characteristics that the UPF is directly connected to the SBA structure through a Service Based Interface (SBI) called Nupf, in addition to the existing N4 interface with the SMF. This is a structure that is currently being standardized in Rel-18, which allows the UPF to directly participate in the service-based structure.

This structure allows the UPF to directly interact with other network functions within the SBA structure in addition to communicating with the SMF via the existing N4 interface, which enables more flexible and efficient network function provision.

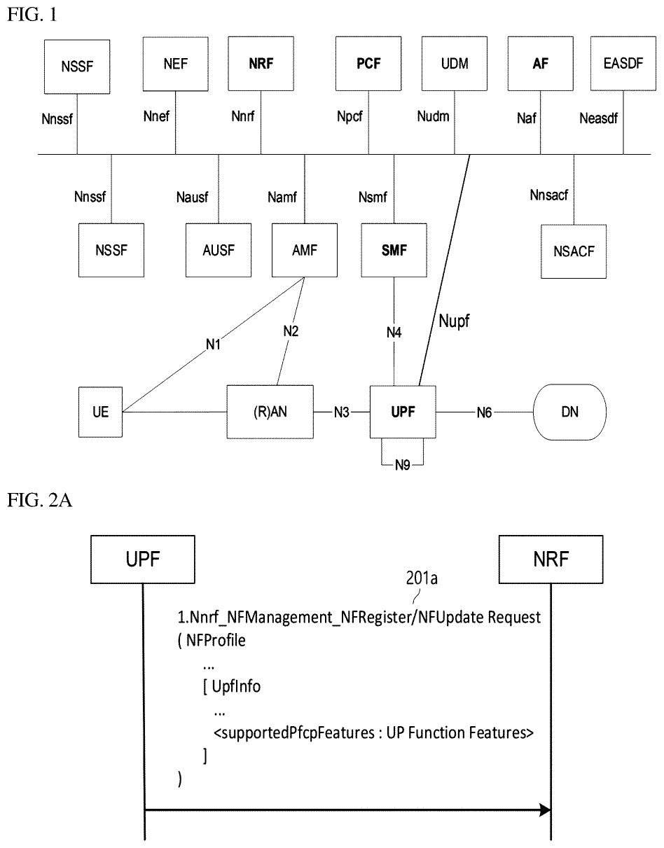

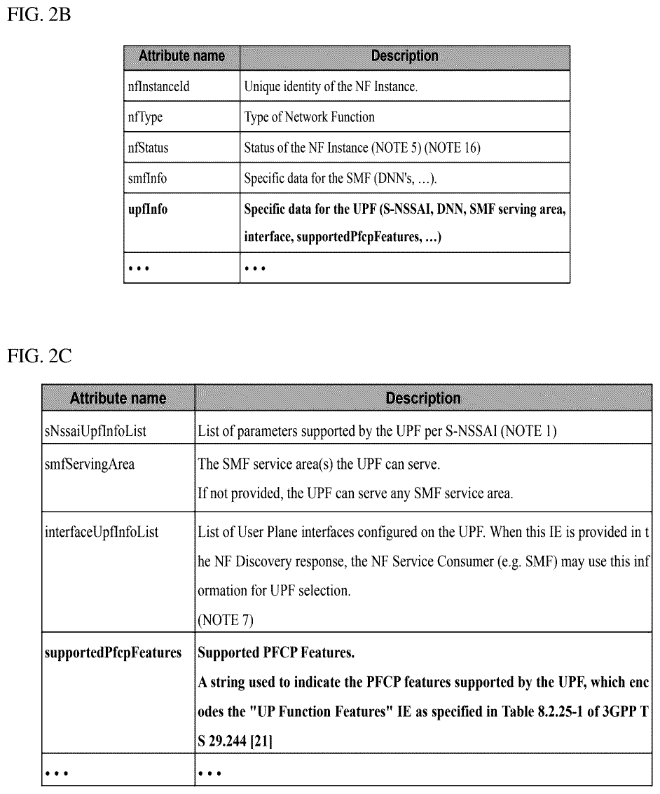

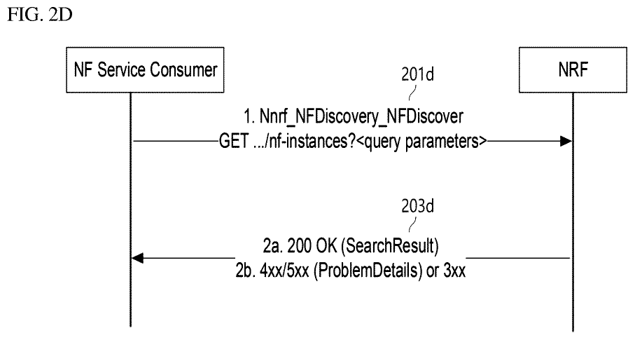

FIG. 2A illustrates a procedure in which a UPF registers its function to an NRF, according to various embodiments of the present disclosure.

Referring to FIG. 2A, the UPF may transmit a registration request to the NRF via NFRegister or NFUpdate operation of Nnrf_NFManagement service (201a). The registration request message may include NFProfile information.

The NFProfile information includes UpfInfo, which indicates functions of the UPF, and the UpfInfo may include UP Function Features information as an attribute called supportedPfcpFeatures.

Such registration procedure allows the UPF to register functions supported by itself to the NRF, and other network functions to search the UPF they need.

FIG. 2A specifically illustrates interactions between the UPF and the NRF in the SBA structure described in FIG. 1, which is a key procedure that enables service discovery between network functions in a 3GPP 5G system.

FIG. 2B illustrates detailed attributes of NFProfile information that the UPF registers with the NRF, according to various embodiments of the present disclosure.

Referring to FIG. 2B, NFProfile may include the following main attributes:

nfInstanceId: may indicate a unique identifier of NF Instance.

nfType: may specify a type of Network Function.

nfStatus: may display status information of NF Instance.

smfInfo: may include specific data (such as DNN) for Session Management Function (SMF).

upfInfo: may include specific data (e.g., S-NSSAI, DNN, SMF serving area, interface, supportedPfcpFeatures) for UPF.

The characteristics and supportable functions of each network function may be defined in detail by using this NFProfile information, which may be used in the registration procedure described in FIG. 2A.

FIG. 2C illustrates detailed attributes of UpfInfo that the UPF registers with the NRF, according to various embodiments of the present disclosure.

Referring to FIG. 2C, UpfInfo may include the following main attributes:

sNssaiUpfInfoList: may include a list of parameters supported by the UPF per S-NSSAI.

smfServingArea: may specify an SMF service area that the UPF may serve. When this information is not provided, the UPF may serve any SMF service areas.

interfaceUpfInfoList: may include a list of user plane interfaces configured on the UPF. When this information is provided in the NF Discovery response, the NF Service Consumer (e.g., SMF) may use this information for UPF selection
supportedPfcpFeatures: may include a string used to indicate the PFCP functions supported by the UPF, which encodes the “UP Function Features” IE as specified in Table 8.2.25-1 of 3GPP TS 29.244.

Such UpfInfo information may be used to inform the NRF of the detailed functions and characteristics of the UPF in the registration procedure of FIG. 2A.

FIG. 2D illustrates a procedure in which an NF Service Consumer searches for a UPF with a specific function in the NRF, according to various embodiments of the present disclosure.

Referring to FIG. 2D, the NF Service Consumer may transmit an NFDiscover operation of the Nnrf NFDiscovery service to the NRF via a GET method (201d). Herein, query parameters may be included to search a UPF with a specific function. For example, query parameters in the form of “NFType=UPF and Upfinfo and supportedPfcpFeatures and BUCP=1” may be configured.

The NRF may send the following messages in response (203d):
2a. 200 OK (SearchResult) if search is successful
2b. 4xx/5xx (ProblemDetails) if search is unsuccessful

Such search procedure allows the NF Service Consumer to efficiently find a UPF that has the specific functionality it needs.

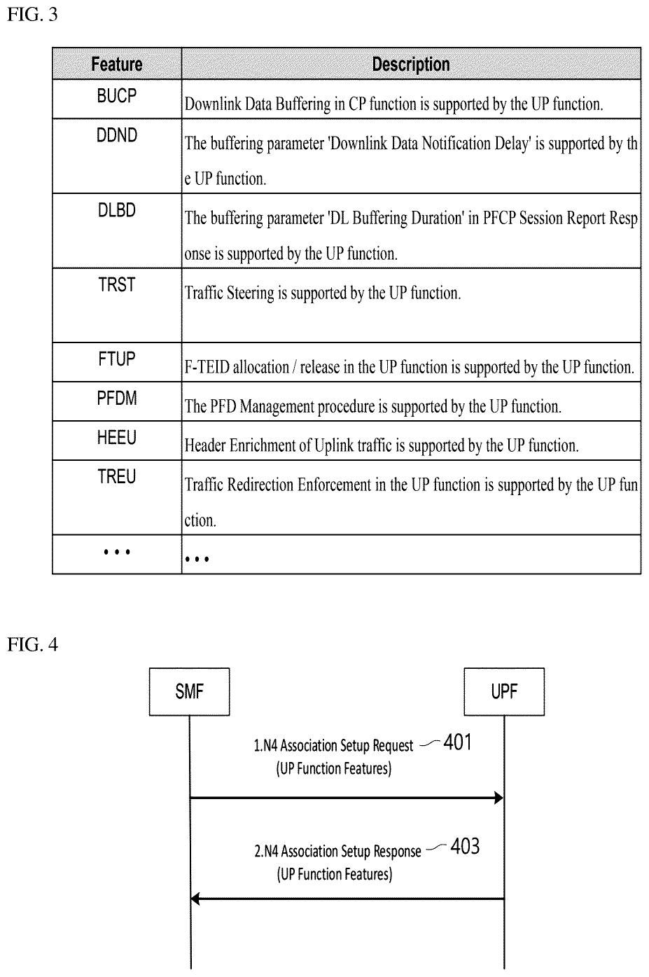

FIG. 3 illustrates details of UP Function Features defined in 3GPP TS 29.244 Table 8.2.25-1, according to various embodiments of the present disclosure.

Referring to FIG. 3, the UP Function Features may include the following main functions:

Downlink Data Buffering in CP function (BUCP): Downlink data buffering functions in CP function is supported by the UP function.

Downlink Data Notification Delay (DDND): The buffering parameter “downlink data notification delay” is supported by the UP function.

DL Buffering Duration (DLBD): The buffering parameter “DL Buffering Duration” in PFCP Session Report Response is supported by the UP function.

Traffic Steering (TRST): Traffic steering is supported by the UP function.

F-TEID allocation/release (FTUP): F-TEID allocation/release in the UP function is supported by the UP function.

PFD Management (PFDM): The PFD management procedures is supported by the UP function.

Header Enrichment of Uplink traffic (HEEU): Header enrichment of uplink traffic is supported by UP function.

Traffic Redirection Enforcement (TREU): Traffic redirection enforcement in the UP function is supported by the UP function.

Such UP Function Features may be used to register functions supported by the UPF to the NRF through the supportedPfcpFeatures property of FIG. 2C.

FIG. 4 illustrates an association setup procedure performed through an N4 interface between a Session Management Function (SMF) and a User Plane Function (UPF), according to various embodiments of the present disclosure.

The procedure of FIG. 4 may be performed in the following order:

(1) The SMF may send N4 Association Setup Request messages to the UPF to check UP Function Features of the UPF (401). The request messages may include parameters requesting UP Function Features.

(2) The UPF may respond to the SMF with information about UP Function Features supported by itself through N4 Association Setup Response message (403).

Such Association Setup procedure allows the SMF to identify functions supported by the UPF, which may be used to check whether the UP Function Features described in FIG. 3 are supported.

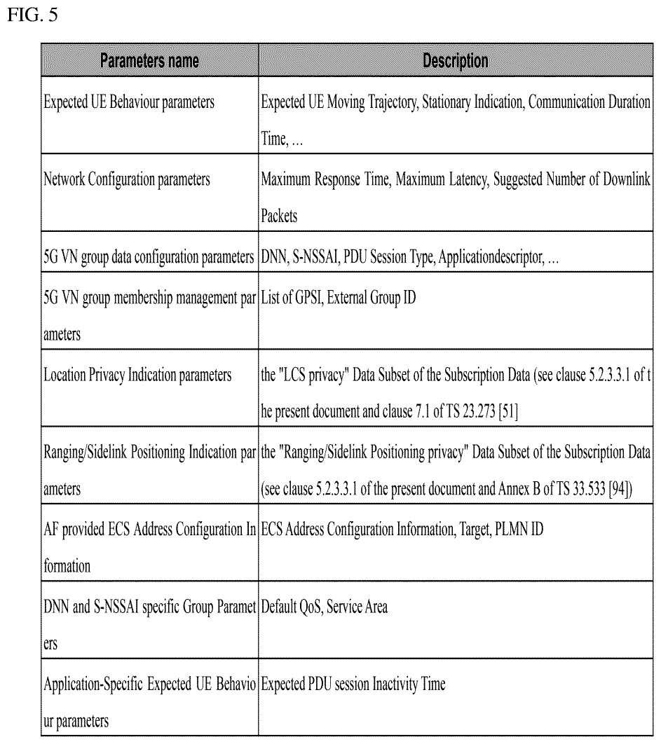

FIG. 5 illustrates provisioning parameters included in the Nnef_ParameterProvison service operation, according to various embodiments of the present disclosure.

The provisioning parameters may include the following items:

Expected UE Behavior parameters: Expected UE moving Trajectory, stationary indication, communication duration time, etc. in the UE may be set.

Network Configuration parameters: Maximum response time, maximum delay, suggested number of downlink packets, etc. may be set

5G VN group data configuration parameters: DNN, S-NSSAI, PDU session type, application descriptor, etc. may be included.

5G VN group membership management parameters: A list of GPSI, external group ID may be included.

Location Privacy Indication parameters: The “LCS privacy” data subset of the subscription data may be included.

Ranging/Sidelink Positioning Indication parameters: The “Ranging/Sidelink Positioning privacy” data subset pf the subscription data may be included.

AF provided ECS Address Configuration Information: ECS address configuration information, target, and PLMN ID may be included.

DNN and S-NSSAI specific Group Parameters: Default QoS and service area may be set.

Application-Specific Expected UE Behavior parameters: Expected PDU session inactivity time may be set.

These provisioning parameters may be used for service provisioning and management between network functions.

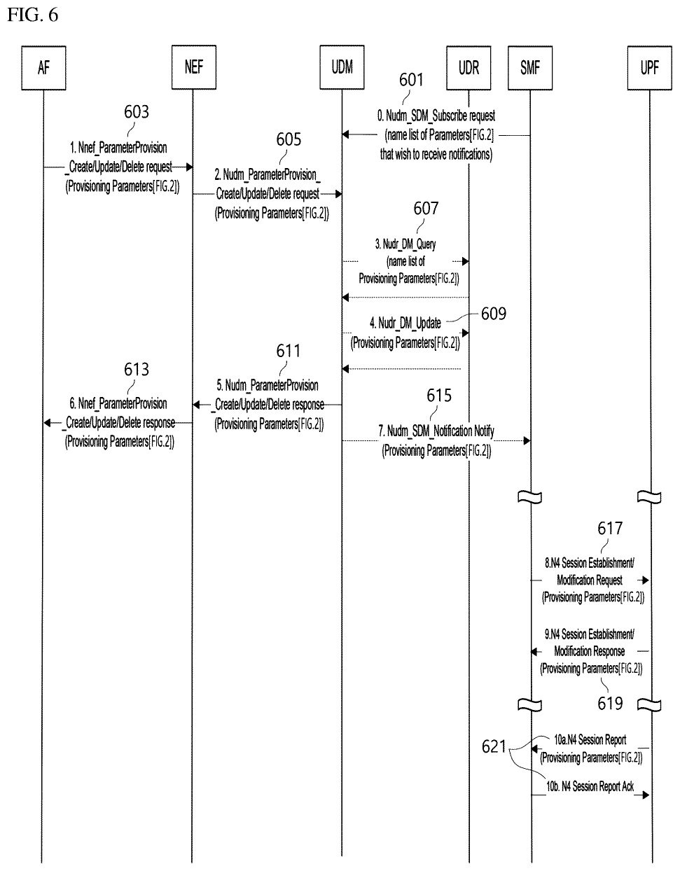

FIG. 6 may illustrate a parameter provisioning procedure by an Application Function (AF), according to various embodiments of the present disclosure.

Referring to FIG. 6, the procedure of FIG. 6 may proceed in the following order:

(1) The SMF may subscribe to provisioning parameter change notification of UDM through Nudm SDM Subscribe service (step 0) (601).

(2) The AF may send provisioning parameters to NEF through Nnef ParameterProvision service (step 1) (603).

(3) The NEF may forward received provisioning parameters to UDM through Nudm ParameterProvision service (step 2) (605).

(4) The UDM may check the validity by sending the list of names of provisioning parameters to UDR (step 3, 4) (607, 609).

(5) The UDM may pass the verification result to NEF as Nudm_ParameterProvision service response (step 5) (611).

(6) The NEF may pass this result to the AF as Nnef_ParameterProvision service response (step 6) (613).

(7) If parameter verification is successful, the UDM may pass the provisioning parameters to the SMF through Nudm_SDM_Notification service (step 7) (615).

(8) The SMF may transfer the received provisioning parameters to the UPF through the N4 Session Establishment/Modification procedure (step 8/9) (617, 619).

(9) When the provisioning-related parameter values of the UPF are changed, the UPF may report this to the SMF through a N4 Session Report procedure (step 10) (621).

Such a procedure allows parameter provisioning started from the AF to be transferred to the UPF through network functions.

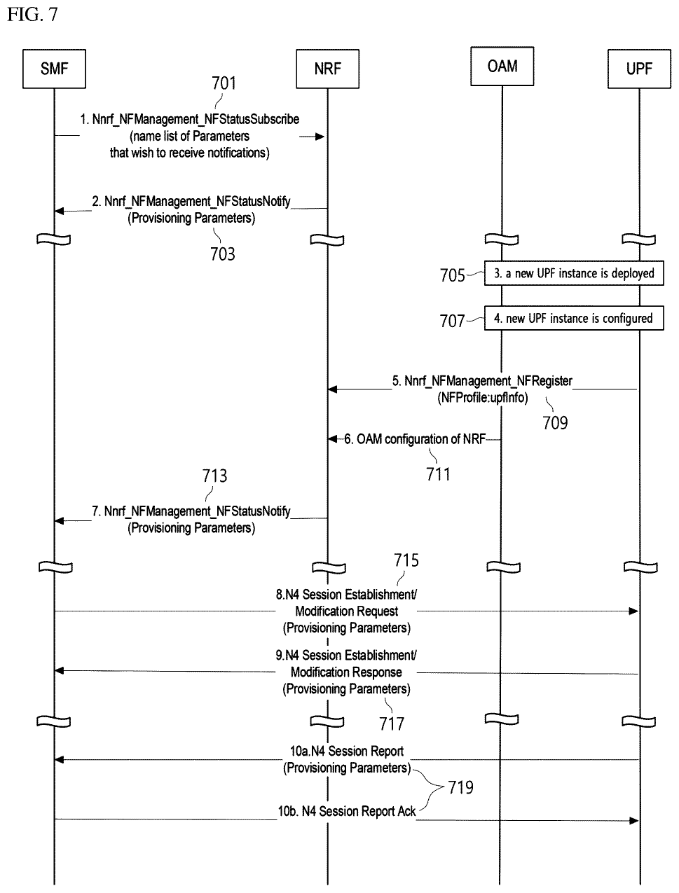

FIG. 7 illustrates a parameter provisioning procedure by a Network Repository Function (NRF), according to various embodiments of the present disclosure.

Referring to FIG. 7, the procedure of FIG. 7 may be performed in the following order:

(1) The SMF may perform a subscription procedure through the Nnrf_NFManagement_NFStatusSubscribe service operation to receive notifications when provisioning parameters are registered with the NRF (step 1) (701).

(2) When the SRF has desired provisioning parameters, the may deliver the parameters to the SMF through the NRF Nnrf_NFManagement_NFStatusNotify service operation (step 2) (703).

(3) A new UPF is registered in the core (step 3) (705), and provisioning parameters for the UPF may be registered in Operation Administration Maintenance (OAM) (step 4) (707).

(4) The new UPF may register NFProfile: upfInfo including information on functions that may be supported by itself to the NRF through the Nnrf_NFManagement NFRegister service operation (step 5) (709).

(5) The OAM may perform the process of transmitting provisioning parameters for the new UPF to the SMF (step 6) (711).

(6) When there are provisioning parameters desired by the SMF, the NRF may transfer the parameters back to the SMF through Nnrf_NFManagement_NFStatusNotify service operation (step 7) (713).

(7) The SMF may transfer provisioning parameters received from the NRF to the UPF through N4 Session Establishment/Modification procedure (steps 8 and 9) (715, 717).

(8) When parameter values set in UPF provisioning related functions are changed, the UPF may report this change event to the SMF through N4 Session Report procedure (step 10) (719).

Such procedure allows parameter provisioning centered on NRF to be efficiently performed between network functions.

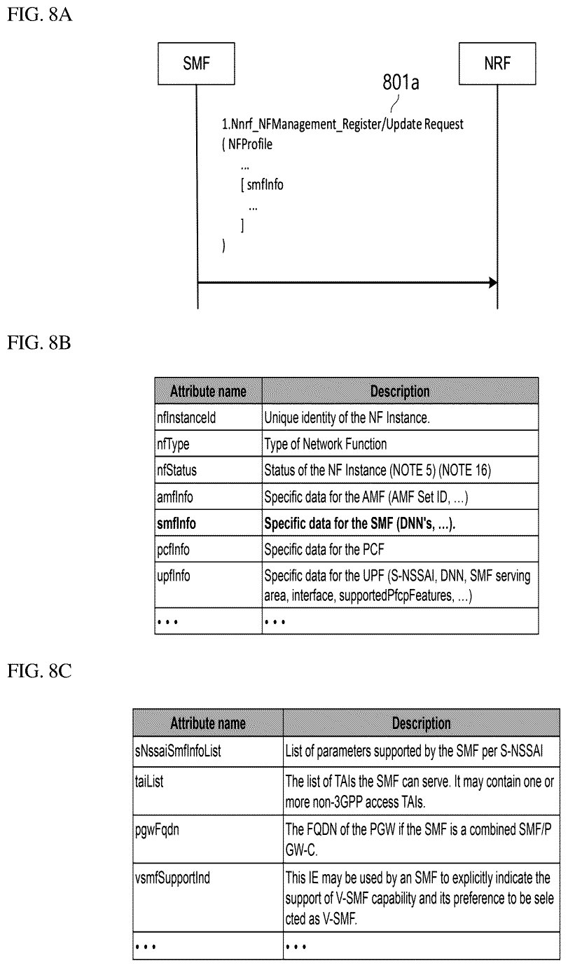

FIG. 8A illustrates a procedure in which Session Management Function (SMF) registers its function to Network Repository Function (NRF), according to various embodiments of the present disclosure.

Referring to FIG. 8A, the SMF may transmit an Nnrf_NFManagement Register Request or Nnrf_NEManagement_Update Request message to the NRF (801a). This message may include NFProfile information, and the NFProfile may include smfInfo information indicating the function of the SMF.

FIG. 8B illustrates detailed attributes of the NFProfile information that the SMF registers with the NRF, according to various embodiments of the present disclosure.

Referring to FIG. 8B, the NFProfile may include basic attributes such as nfInstanceId, nfType, and nfStatus, similar to FIG. 2B, and may also include attribute names such as amfInfo, smfInfo, pcfInfo, and upfInfo indicating specific data for each network function.

In particular, smfInfo may include information such as DNN as specific data for the SMF, which may be used in the NRF registration procedure of SMF described in FIG. 8A.

FIG. 8C illustrates detailed attributes of smfInfo that SMF registers with NRF, according to various embodiments of the present disclosure.

Referring to FIG. 8C, smfInfo may include the following attributes:
sNssaiSmfInfoList: A list of parameters supported by SMF per S-NSSAI may be included.
taiList: The list of TAIs that the SMF may be included. It may contain one or more non-3GPP access TAIs.
pgwFqdn: The FQDN of the PGW may be included if the SMF is a combined SMF/PGW-C.
vsmfSupportInd: This IE may be used by an SMF to explicitly indicate the support of V-SMF capability and its preference to be selected as V-SMF.

This information may be used to define detailed capability and characteristics of SMF, as part of NFProfile used in NRF registration procedure of SMF described in FIG. 8A.

FIG. 8D illustrates a procedure in which another NF searches Session Management Function (SMF) with specific functionality in a Network Repository Function (NRF), according to various embodiments of the present disclosure.

Referring to FIG. 8D, another NF may send Nnrf NFDiscovery Request service to the NRF to find SMF with specific capability (801d). Herein, query-parameters for finding SMF with specific capability may be included, and query-parameters may be configured in the form of “NFType=SMF& vsmfSupport Ind=true”, for example.

The NRF may send the following messages in response (803d):
2a. 200 OK (SearchResult) if search is successful
2b. 4xx/5xx (ProblemDetails) or 3xx if search is unsuccessful

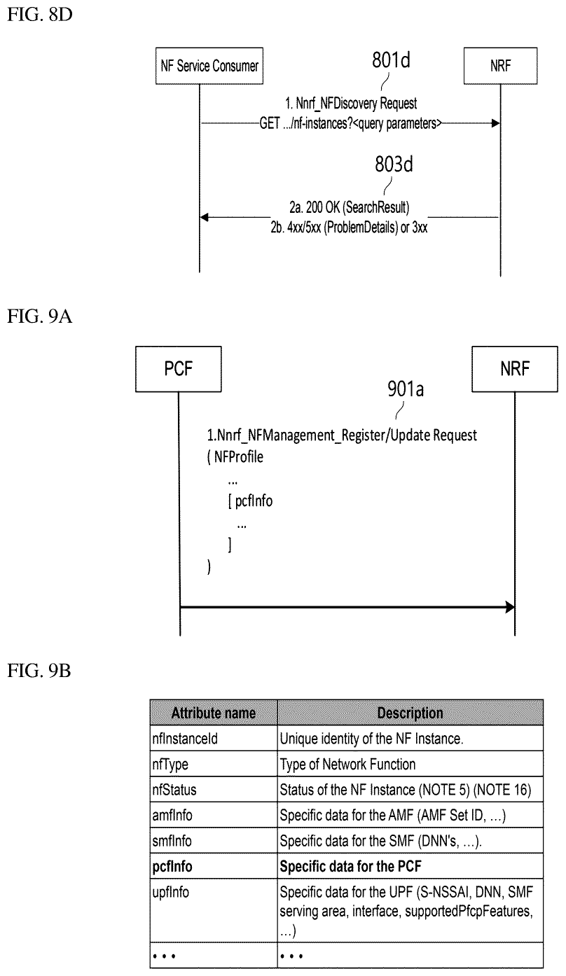

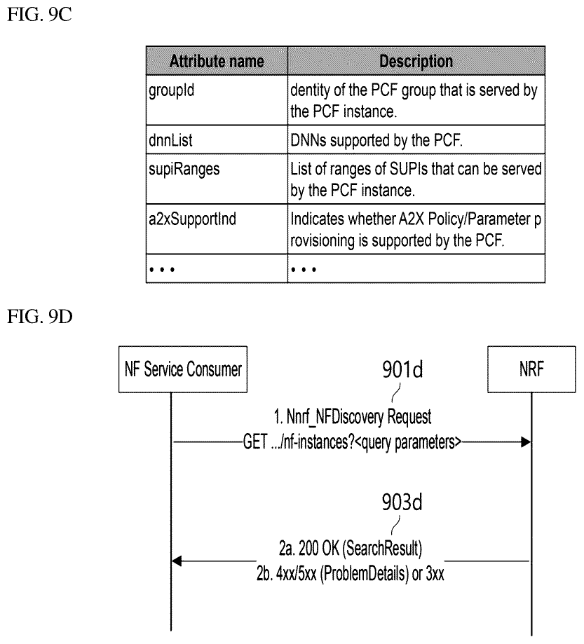

FIG. 9A illustrates a procedure in which a Policy Control Function (PCF) registers its function to a Network Repository Function (NRF), according to various embodiments of the present disclosure. Specifically, the procedure in which the Policy Control Function (PCF) registers its function to the Network Repository Function (NRF) may be illustrated in the form similar to FIG. 8A.

Referring to FIG. 9A, the PCF may send a Nnrf_NFManagement_Register Request or Nnrf_NFManagement_Update Request message to the NRF (901a). This message may contain NFProfile information, and the NFProfile may contain pcfInfo information indicating the function of the PCF.

This registration procedure allows the PCF to register functions supported by itself to the NRF, so that other network functions may discover PCFs they need.

FIG. 9B illustrates detailed attributes of NFProfile information that the PCF registers with the NRF, according to various embodiments of the present disclosure. Specifically, FIG. 9B may illustrate detailed attributes of NFProfile information that the PCF registers with the NRF in a table format that is the same as described in FIG. 2B and FIG. 8B.

Referring to FIG. 9B, NFProfile may include basic attributes such as nfInstanceId, nfType, and nfStatus that are the same as in FIG. 2B and FIG. 8B, and may also include attributes such as amfInfo, smfInfo, pcfInfo, and upfInfo that represent specific data for each network function.

In particular, pcfInfo may include specific data for PCF, which may be used in the NRF registration procedure of PCF described in FIG. 9A.

FIG. 9C illustrates detailed attributes of pcfInfo that PCF registers with NRF according to various embodiments of the present disclosure. Specifically, FIG. 9C may illustrate detailed attributes of pcfInfo that PCF registers with NRF in a table format that is similar to UpfInfo of FIG. 2C and smfInfo of FIG. 8C.

pcfInfo may include the following attributes:
groupId: Identifier of the PCF group that is served by the PCF instance may be contained.
dnnList: DNNs supported by the PCF may be contained.
supiRanges: A list of SUPI ranges that may be served by the PCF instance may be contained.
a2×SupportInd: Indicates whether A2X Policy/Parameter provisioning is supported by the PCF.

Such information may be used to define detailed functions and characteristics of the PCF, as part of the NFProfile used in the NRF registration procedure of the PCF described in FIG. 9A.

FIG. 9D may illustrate a procedure in which an NF Service Consumer searches a PCF with a specific function in the NRF, according to various embodiments of the present disclosure. FIG. 9D may illustrate the procedure in which the NF Service Consumer search the PCF with a specific function in the NRF in a form that is similar to FIG. 2D and FIG. 8D.

Referring to FIG. 9D, the NF Service Consumer may transfer an Nnrf NFDiscovery Request service to the NRF via a GET method, in which it may search a PCF with a specific function including query parameters (901d). For example, query parameters may be configured in the form of “NFType=PCF&a2×SupportInd=true”.

The NRF may send the following messages in response (903d):
2a. 200 OK (SearchResult) if search is successful
2b. 4xx/5xx (ProblemDetails) or 3xx if search is unsuccessful

Such search procedure allows the NF Service Consumer to efficiently find a PCF that has specific capability needed by itself.

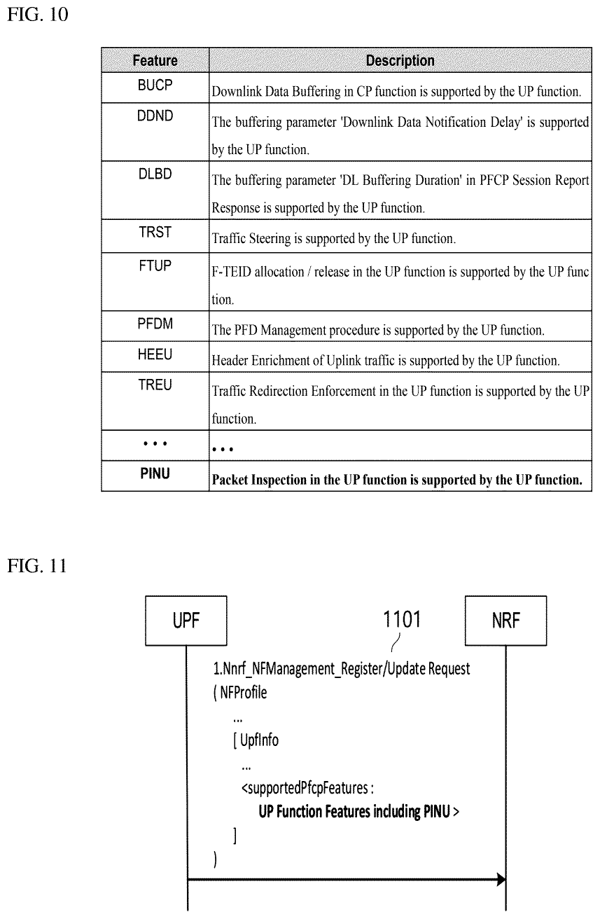

FIG. 10 illustrates UP Function Features containing Packet Inspection Feature for the UPF of a 5G system to provide UP Function Features information to the NRF or the SMF, according to an embodiment of the present disclosure.

Referring to FIG. 10, the UP Function Features may contain Packet Inspection in the UP function (PINU) function that is newly added in the present disclosure, in addition to the existing functions (BUCP, DDND, DLBD, TRST, FTUP, PEDM, HEEU, TREU, etc.) described in FIG. 3.

The UP Function Features may be used to register functions supported by the UPF to the NRF and to be searched by other network functions and, in particular, packet inspection may be supported by the UPF through the newly added PINU function.

FIG. 11 illustrates a procedure for registering UPF including Packet Inspection Feature (PINU) to NRF, according to an embodiment of the present disclosure.

Referring to FIG. 11, the UPF may send Nnrf_NFManagement_Register Request or Nnrf_NFManagement_Update Request message to NRF (1101). This message may include NFProfile information, and UpfInfo in NFProfile may include the UP Function Features including PINU described in FIG. 10 as supportedPfcpFeatures property.

This registration procedure allows the UPF to be registered to the NRF that it supports packet inspection functionality.

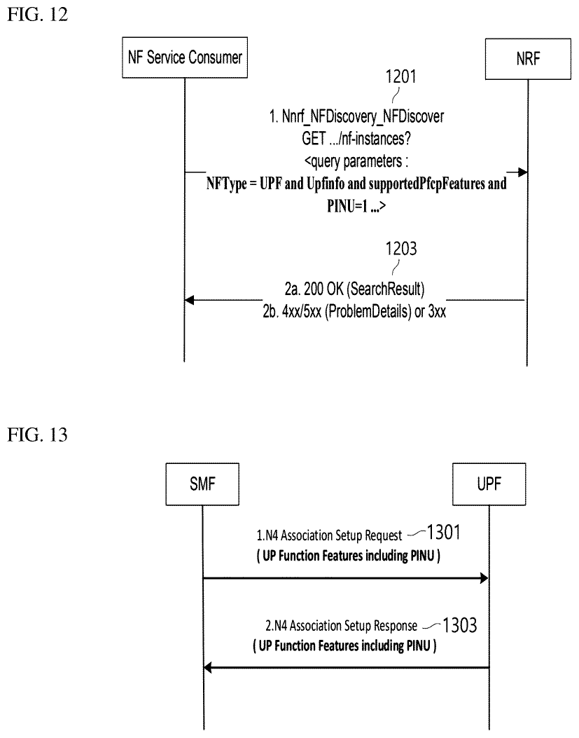

FIG. 12 illustrates a procedure in which NF Service Consumer searches a NRF for a UPF containing packet inspection feature (PINU), according to an embodiment of the present disclosure.

Referring to FIG. 12, the NF Service Consumer may transfer Nnrf NFDiscovery NFDiscover service to the NRF through GET method (1201). Herein, the query parameters may include a condition for searching for UPFs with packet inspection functionality, such as “NFType=UPF and UpfInfo and supportedPfcpFeatures and PINU=1”.

In response, the NRF may send the following message (1203):
2a. 200 OK (SearchResult) if search is successful
2b. 4xx/5xx (ProblemDetails) or 3xx if search is unsuccessful

This search procedure allows the NF Service Consumer to find a UPF that supports packet inspection functionality.

FIG. 13 illustrates a procedure in which a UPF provides UP Function Features containing a packet inspection feature (PINU) to an SMF in an Association Setup procedure between an SMF and a UPF, according to an embodiment of the present disclosure.

Referring to FIG. 13, a procedure of FIG. 13 may be performed in the following order:

(1) The SMF may request UP Function Features including Packet Inspection Feature (PINU) from the UPF through N4 Association Setup Request message (1301).

(2) The UPF may respond to the SMF, through N4 Association Setup Response messages, UP Function Features including a Packet Inspection Feature (PINU) supported by itself (1303).

This procedure allows the SMF to check whether the UPF supports the packet inspection functionality.

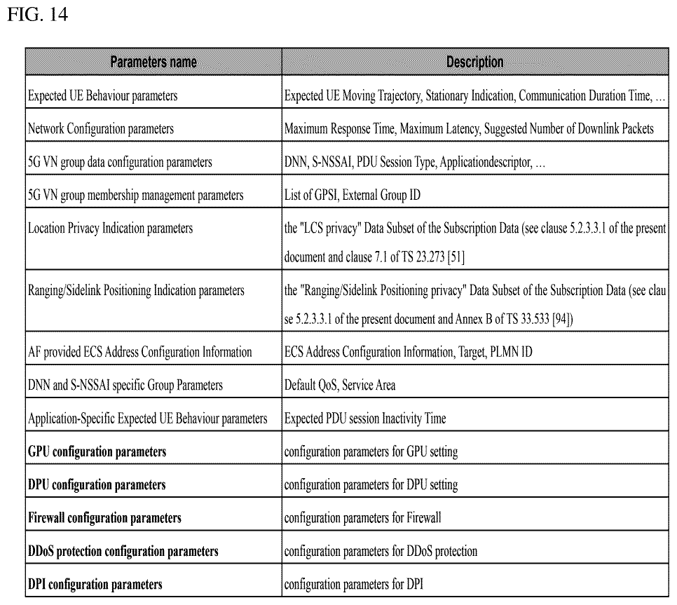

FIG. 14 illustrates provisioning parameters included in the Nnef_ParameterProvison service operation, according to an embodiment of the present disclosure.

The existing provisioning parameters may include the following items:
(1) Expected UE Behavior parameters
(2) Network Configuration parameters
(3) 5G VN group data configuration parameters
(4) 5G VN group membership management parameters
(5) Location Privacy Indication parameters
(6) Ranging/Sidelink Positioning Indication parameters
(7) AF provided ECS Address Configuration Information
(8) DNN and S-NSSAI specific Group Parameters
(9) Application-Specific Expected UE Behavior parameters

The following new parameters may be added herein:
(1) GPU configuration parameters: Configuration parameters for GPU configuration
(2) DPU configuration parameters: Configuration parameters for DPU configuration
(3) Firewall configuration parameters: Configuration parameters for firewall
(4) DDoS protection configuration parameters: Configuration parameters for DDoS protection
(5) DPI configuration parameters: Configuration parameters for DPI

These provisioning parameters may be used for service provisioning and management between network functions.

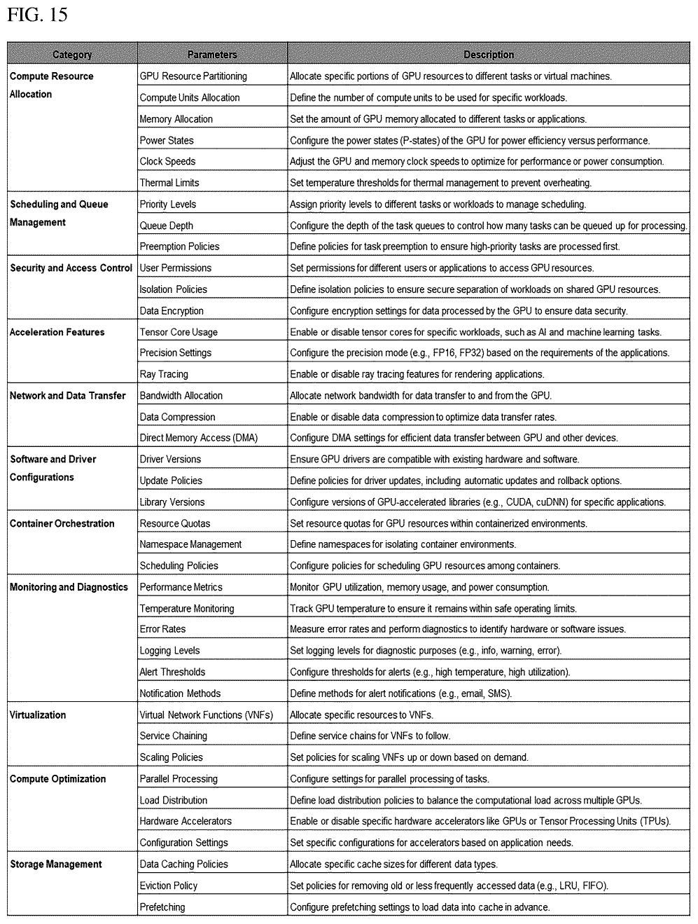

FIG. 15 illustrates detailed provisioning parameters for GPU configuration per category, according to an embodiment of the present disclosure.

Referring to FIG. 15, GPU configuration provisioning parameters may be divided into the following categories:

(1) Compute Resource Allocation:
GPU Resource Partitioning, Compute Units Allocation, Memory Allocation, Power States, Clock Speeds, Thermal Limits, etc. may be contained.

(2) Scheduling and Queue Management:
Priority Levels, Queue Depth, Preemption Policies, etc. may be contained.

(3) Security and Access Control:
User Permissions, Isolation Policies, Data Encryption, etc. may be contained.

(4) Acceleration Features:
Tensor Core Usage, Precision Settings, Ray Tracing, etc. may be contained.

(5) Network and Data Transfer:
Bandwidth Allocation, Data Compression, Direct Memory Access, etc. may be contained.

(6) Software and Driver Configurations:
Driver Versions, Update Policies, Library Versions, etc. may be contained.

(7) Container Orchestration:
Resource Quotas, Namespace Management, Scheduling Policies, etc. may be contained.

(8) Monitoring and Diagnostics:
Performance Metrics, Temperature Monitoring, Error Rates, Logging Levels, etc. may be contained.

(9) Virtualization:
Virtual Network Functions, Service Chaining, Scaling Policies, etc. may be contained.

(10) Storage Management:
Data Caching Policies, Eviction Policy, Prefetching, etc. may be contained.

Through these detailed parameters, various functions and performances of the GPU may be finely controlled and managed.

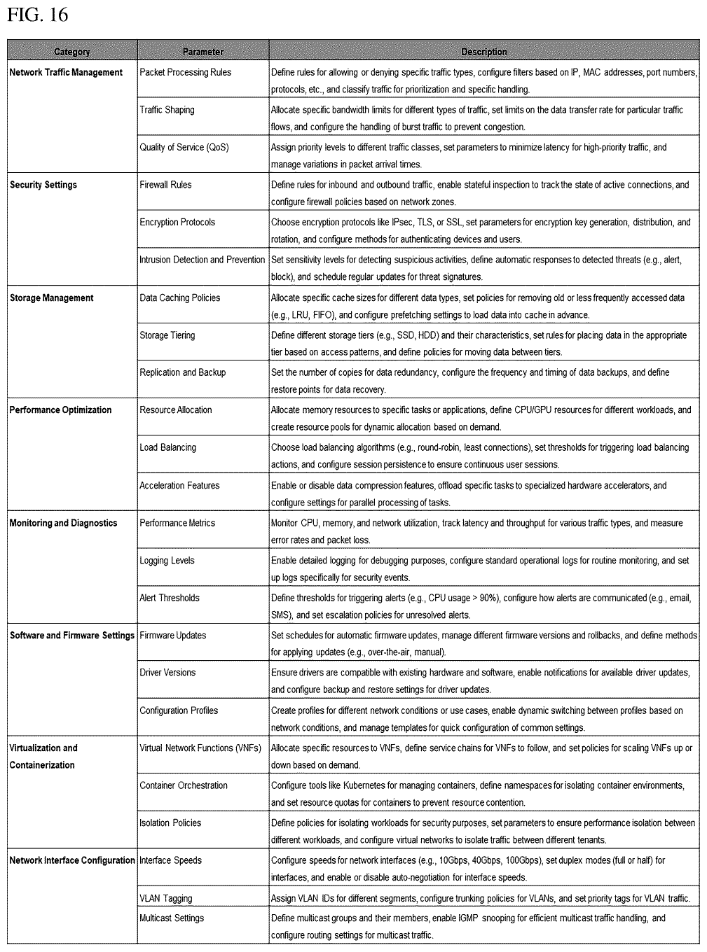

FIG. 16 illustrates detailed provisioning parameters for DPU configuration per category, according to an embodiment of the present disclosure.

Referring to FIG. 16, DPU configuration provisioning parameters may be classified into the following categories:

(1) Network Traffic Management:
Packet Processing Rules, Traffic Shaping, Quality of Service (QoS), etc. may be contained.

(2) Security Settings:
Firewall Rules, Encryption Protocols, Intrusion Detection and Prevention, etc. may be contained.

(3) Storage Management:
Data Caching Policies, Storage Tiering, Replication and Backup, etc. may be contained.

(4) Performance Optimization:
Resource Allocation, Load Balancing, Acceleration

Features, etc. may be contained.

(5) Monitoring and Diagnostics:
Performance Metrics, Logging Levels, Alert Thresholds, etc. may be contained.

(6) Software and Firmware Settings:
Firmware Updates, Driver Versions, Configuration Profiles, etc. may be contained.

(7) Virtualization and Containerization:
Virtual Network Functions (VNFs), Container Orchestration, Isolation Policies, etc. may be contained.

(8) Network Interface Configuration:
Interface Speeds, VLAN Tagging, Multicast Settings, etc. may be contained.

Such detailed parameters may allow various functions and performances of the DPU to be finely controlled and managed.

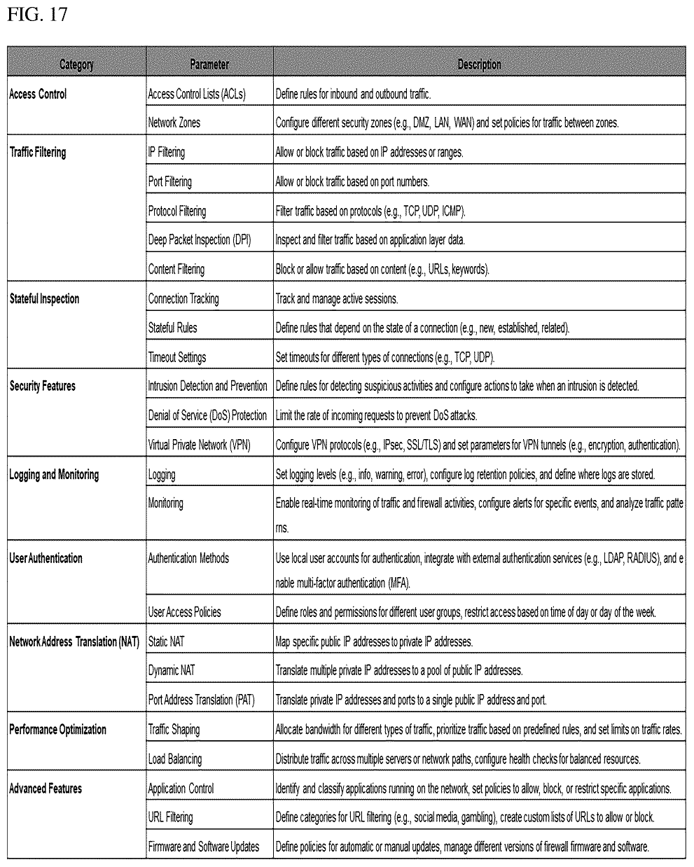

FIG. 17 illustrates detailed provisioning parameters for firewall configuration per category, according to an embodiment of the present disclosure.

Referring to FIG. 17, the firewall configuration provisioning parameters may be divided into the following categories:

Access Control:
Access Control Lists (ACLs), Network Zones, etc. may be contained.

(2) Traffic Filtering:
IP Filtering, Port Filtering, Protocol Filtering, Deep Packet Inspection (DPI), Content Filtering, etc. may be contained.

(3) Stateful Inspection:
Connection Tracking, Stateful Rules, Timeout Settings, etc. may be contained.

(4) Security Features:
Intrusion Detection and Prevention, Denial of Service (DOS) Protection, Virtual Private Network (VPN), etc. may be contained.

(5) Logging and Monitoring:
Logging, Monitoring, etc. may be contained.

(6) User Authentication:
Authentication Methods, User Access Policies, etc. may be contained.

(7) Network Address Translation (NAT):
Static NAT, Dynamic NAT, Port Address Translation (PAT), etc. may be contained.

(8) Performance Optimization:
Traffic Shaping, Load Balancing, etc. may be contained.

(9) Advanced Features:
Application Control, URL Filtering, Firmware and Software Updates, etc. may be contained.

Such detailed parameters may allow various security functions and performances of the firewall to be finely controlled and managed.

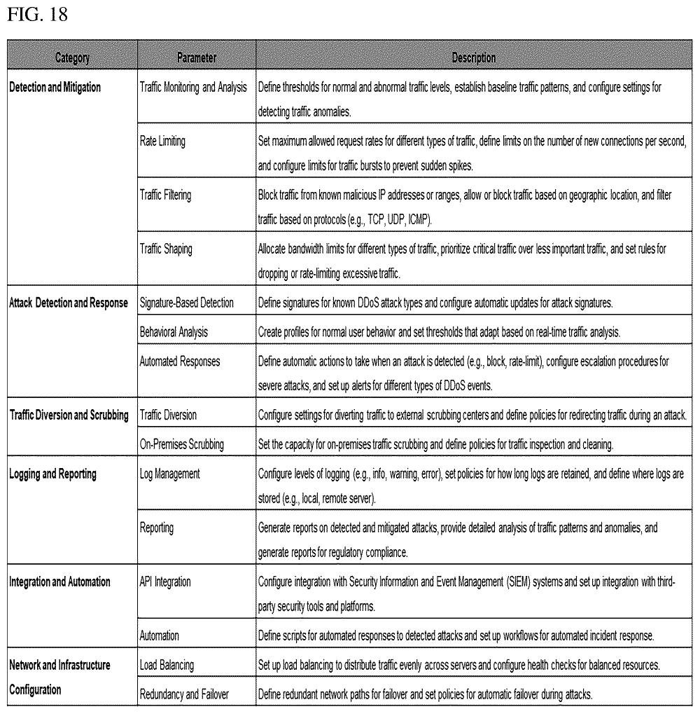

FIG. 18 may illustrate detailed provisioning parameters for configuring Distributed Denial of Service (DDoS) protection per category, according to an embodiment of the present disclosure. The DDoS protection configuration provisioning parameters may be divided into the following categories:

(1) Detection and Mitigation:
Traffic Monitoring and Analysis: Define thresholds for normal/abnormal traffic levels and establish baseline traffic patterns.
Rate Limiting: Set maximum allowed request rate and define limits on the number of new connections by traffic type.
Traffic Filtering: Block traffic based on IP address, range, or protocols.
Traffic Shaping: Allocate bandwidth limits for different types of traffic and prioritize critical traffic.

(2) Attack Detection and Response:
Signature-Based Detection: Define signatures of known DDoS attack types.
Behavioral Analysis: Create normal user behavior profiles based on real-time traffic analysis.
Automated Responses: Define automatic action to take when an attack is detected.

(3) Traffic Diversion and Scrubbing:
Traffic Diversion: Configure settings for diverting traffic to external scrubbing center.
On-Premises Scrubbing: Set the capacity for traffic inspection and cleaning.

(4) Logging and Reporting:
Log Management: Configure levels of logging and set policies for how long logs are retained period.
Reporting: Generate detailed reports on detected and mitigated attacks.

(5) Integration and Automation:
API Integration: Configure integration with security information and event management systems.
Automation: Define scripts for automated responses to detected attacks.

(6) Network and Infrastructure Configuration:
Load Balancing: Set up load balancing to distribute traffic between servers and resources.
Redundancy and Failover: Define redundant network paths for failover.

Such detailed parameters may allow detection, defense, and response to DDoS attacks to be finely controlled and managed.

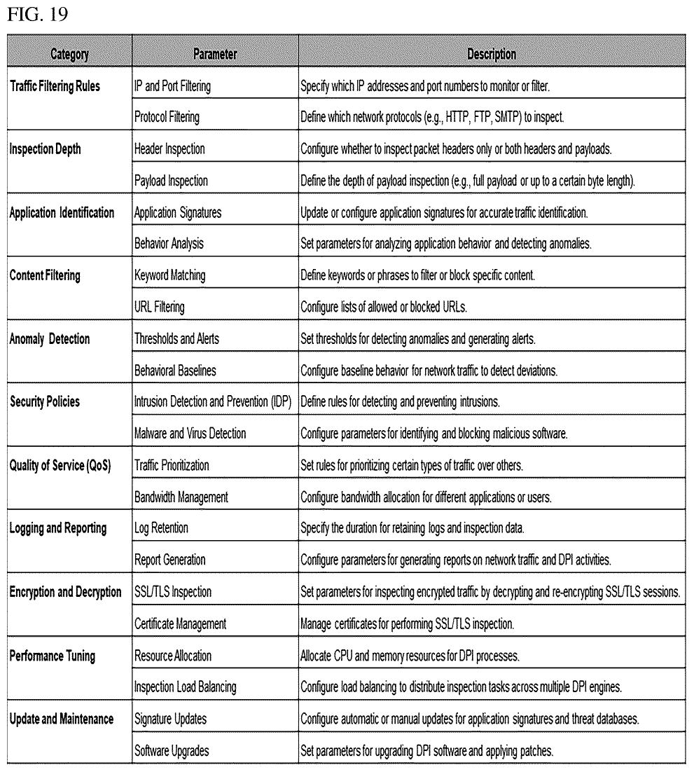

FIG. 19 illustrates detailed provisioning parameters for DPI configuration per category, according to an embodiment of the present disclosure.

Referring to FIG. 19, DPI configuration provisioning parameters may be divided into the following categories:

(1) Traffic Filtering Rules:
IP and Port Filtering, Protocol Filtering, etc. may be contained.

(2) Inspection Depth:
Header Inspection, Payload Inspection, etc. may be contained.

(3) Application Identification:
Application Signatures, Behavior Analysis, etc. may be contained.

(4) Content Filtering:
Keyword Matching, URL Filtering, etc. may be contained.

(5) Anomaly Detection:
Thresholds and Alerts, Behavioral Baselines, etc. may be contained.

(6) Security Policies:
Intrusion Detection and Prevention (IDP), Malware and Virus Detection, etc. may be contained.

(7) Quality of Service (QoS):
Traffic Prioritization, Bandwidth Management, etc. may be contained.

(8) Logging and Reporting:
Log Retention, Report Generation, etc. may be contained.

(9) Encryption and Decryption:
SSL/TLS Inspection, Certificate Management, etc. may be contained.

(10) Performance Tuning:
Resource Allocation, Inspection Load Balancing, etc. may be contained.

(11) Update and Maintenance:
Signature Updates, Software Upgrades, etc. may be contained.

These detailed parameters may be used to finely control and manage various packet inspection functionalities and performances of DPI.

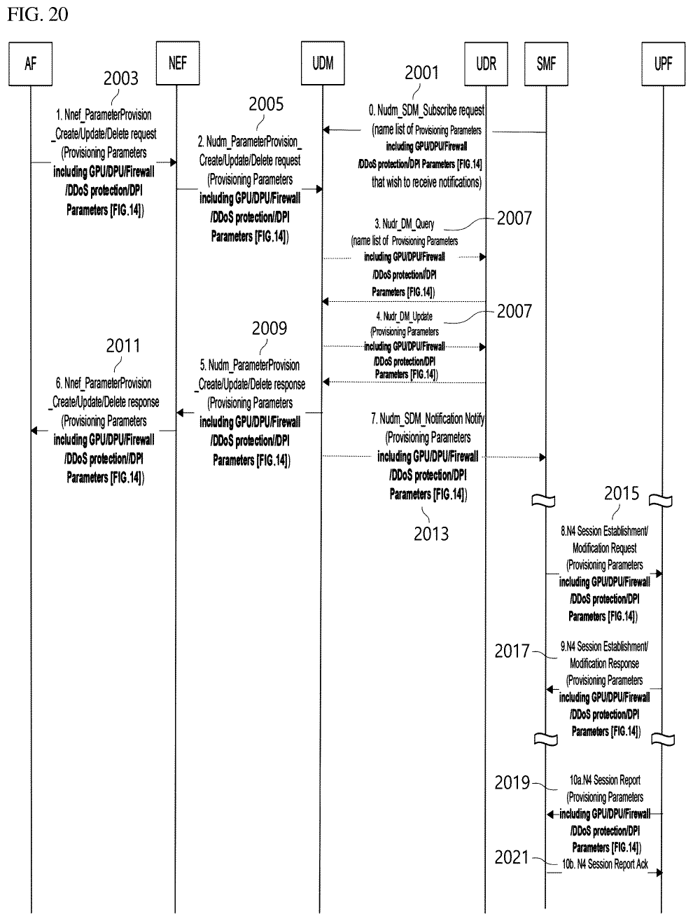

FIG. 20 may illustrate a parameter provisioning procedure by an AF including GPU, DPU, firewall, DDoS protection, and DPI configuration parameters, according to an embodiment of the present disclosure.

Referring to FIG. 20, the procedure of FIG. 20 may proceed in the following order:

(1) The AF may transmit Nnef_ParameterProvision CreateOrUpdate Service Request message to a NEF (2001). This message may include GPU/DPU/Firewall/DDoS/DPI provisioning parameters (FIG. 14).

(2) the NEF may transmit Nudm_ParameterProvision CreateOrUpdateData Request message to a UDM (2003). This message may contain GPU/DPU/Firewall/DDoS/DPI provisioning parameters (FIG. 14).

(3) The UDM may check GPU/DPU/Firewall/DDoS/DPI provisioning parameters (FIG. 14) through a UDR and Nudr_DM_Query procedures (2005).

(4) The UDM may update GPU/DPU/Firewall/DDoS/DPI provisioning parameters (FIG. 14) through a UDR and Nudr_DM_Update procedures (2007).

(5) The UDM may respond to the NEF with CreateOrUpdateData Response (2009).

(6) The NEF may respond to the AF with CreateOrUpdate Service Response (2011).

(7) The UDM may deliver GPU/DPU/Firewall/DDoS/DPI provisioning parameters (FIG. 14) to the SMF through Nudm_SDM_Notification (2013).

(8) The SMF may send N4 Session Establishment/Modification Request to the UPF (2015). This message may include GPU/DPU/Firewall/DDoS/DPI provisioning parameters (FIG. 14).

(9) The UPF may respond to the SMF with an N4 Session Establishment/Modification Response (2017). This message may include GPU/DPU/Firewall/DDoS/DPI provisioning parameters (FIG. 14).

(10a) The UPF may send an N4 Session Report to the SMF (2019). This message may include GPU/DPU/Firewall/DDoS/DPI provisioning parameters (FIG. 14).

(10b) The SMF may respond to the UPF with an N4 Session Report Ack (2021).

Such procedure may allow provisioning of GPU, DPU, firewall, DDoS protection, and DPI configuration parameters originated from the AF to be passed ultimately to the UPF through network functions.

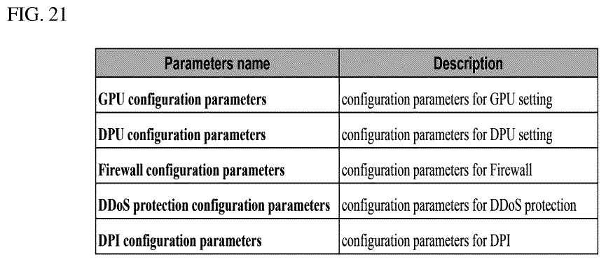

FIG. 21 illustrates provisioning parameters included in the Nnrf_NFManagement service operation, according to an embodiment of the present disclosure.

Referring to FIG. 21, provisioning parameters may include the following items:
GPU configuration parameters: Configuration parameters for GPU configuration
DPU configuration parameters: Configuration parameters for DPU configuration
Firewall configuration parameters: Configuration parameters for firewall
DDoS protection configuration parameters: Configuration parameters for DDoS protection
DPI configuration parameters: Configuration parameters for DPI

These provisioning parameters may include each of the detailed parameters defined in FIGS. 15-19.

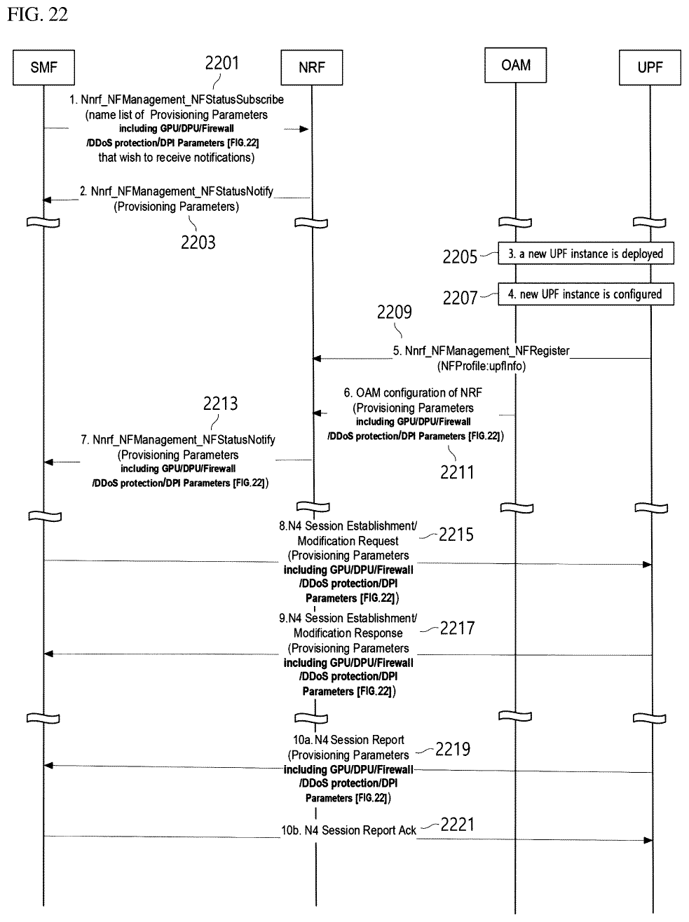

FIG. 22 illustrates a parameter provisioning procedure by NRF, according to an embodiment of the present disclosure.

Referring to FIG. 22, the procedure of FIG. 22 may proceed in the following order:

(1) A SMF may register, to an NRF, a name list of parameters for which it wishes to receive notifications of GPU/DPU/Firewall/DDoS protection/DPI Parameters (FIG. 22) through Nnrf_NFManagement_NFStatusSubscribe service (2201).

(2) The NRF may deliver provisioning parameters to the SMF through Nnrf_NFManagement_NFStatusNotify service (2203).

(3) A new UPF instance may be deployed (2205).

(4) A new UPF instance may be configured (2207).

(5) A new UPF may register NFProfile and upfInfo to the NRF through Nnrf_NFManagement_NFRegister service (2209).

(6) The OAM may configure the NRF with provisioning parameters including GPU/DPU/Firewall/DDoS protection/DPI Parameters (FIG. 22) (2211).

(7) The NRF may transfer provisioning parameters including GPU/DPU/Firewall/DDoS protection/DPI Parameters (FIG. 22) to the SMF through Nnrf_NFManagement_NFStatusNotify service (2213).

(8) The SMF may transfer provisioning parameters including GPU/DPU/Firewall/DDoS protection/DPI Parameters (FIG. 22) to the UPF through N4 Session Establishment/Modification Request (2215).

(9) The UPF may respond with an N4 Session Establishment/Modification Response (2217).

(10a) The UPF may deliver provisioning parameters including GPU/DPU/Firewall/DDoS protection/DPI Parameters (FIG. 22) to the SMF via N4 Session Report (2219)

(10b) The SMF may respond with N4 Session Report Ack (2221).

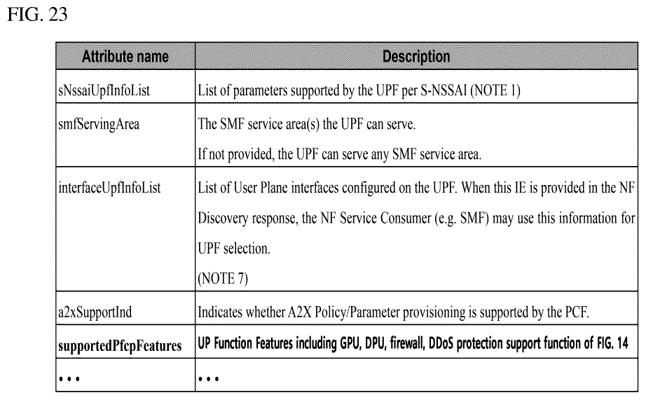

FIG. 23 illustrates detailed attributes of upfInfo that the UPF registers with the NRF, according to an embodiment of the present disclosure.

Referring to FIG. 23, upfInfo may include the following attributes:
sNssaiUpfInfoList: A list of parameters supported by UPF per S-NSSAI may be contained.
smfServingArea: The SMF service area that the UPF may serve may be defined. If not provided, the UPF may serve any SMF service areas.
interfaceUpfInfoList: A list of user plane interfaces configured on the UPF may be contained. When this information is provided in the NF Discovery response, the NF Service Consumer (e.g., SMF) may use this information for UPF selection.
a2×SupportInd: Whether A2X Policy/Parameter provisioning is supported by the PCF is indicated.
supportedPfcpFeatures: UP Function Features including GPU, DPU, firewall, DDoS protection, and DPI support features of FIG. 14 may be indicated.

This upfInfo information may be used in the parameter provisioning procedure by NRF described in FIG. 22.

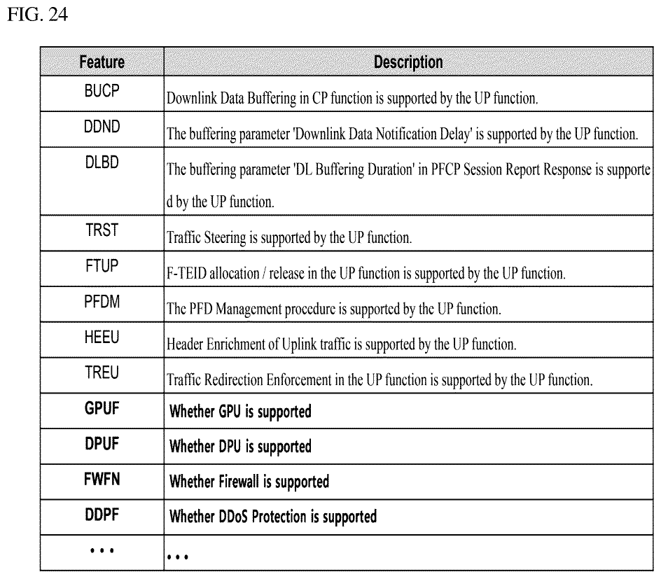

FIG. 24 illustrates a form in which new functions are added to the existing UP Function Features, according to an embodiment of the present disclosure.

Referring to FIG. 24, the existing UP Function Features may include the following functions:
BUCP: Downlink data buffering in CP function may be supported by the UP function.
DDND: The buffering parameter “downlink data notification delay” may be supported by the UP function.
DLBD: The buffering parameter “downlink buffering duration parameter” in PFCP Session Report Response is supported by the UP function.
TRST: traffic steering is supported by the UP function.
FTUP: F-TEID allocation and release in the UP function is supported by the UP function.
PFDM: The PFD management procedures is supported by the UP function.
HEEU: Header reinforcement of uplink traffic is supported by the UP function.
TREU: Traffic redirection enforcement in the UP function is supported by the UP function.

The newly added features are as follows:
GPUF: Whether GPU is supported
DPUF: Whether DPU is supported
FWEN: Whether Firewall is supported
DDPF: Whether DDoS Protection is supported

Such UP Function Features may be used as the supportedPfcpFeatures attribute in upfInfo of FIG. 23.

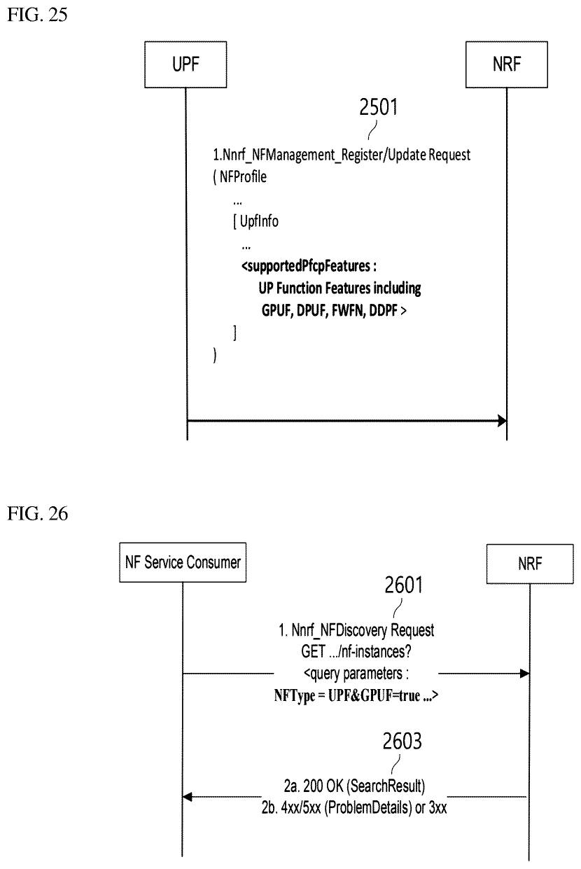

FIG. 25 illustrates a procedure in which a UPF registers GPU, DPU, firewall, and DDoS protection support features to an NRF, according to an embodiment of the present disclosure.

Referring to 25, FIG. the UPF may transfer Nnrf_NFManagement_Register Request or Nnrf_NFManagement_Update Request message to the NRF (2501). This message may include NFProfile information, and UpfInfo in NFProfile may include UP Function Features including GPU support (GPUF), DPU support (DPUF), firewall support (FWEN), and DDoS protection support (DDPF) Features defined in FIG. 24 as supportedPfcpFeatures attributes.

Such registration procedure allows the UPF to register GPU, DPU, firewall, and DDoS protection features supported by itself to the NRF.

FIG. 26 illustrates a procedure in which an NF Service Consumer searches an NRF for a UPF with GPU support feature, according to an embodiment of the present disclosure.

Referring to FIG. 26, the NF Service Consumer may transfer Nnrf_NFDiscovery Request service to the NRF through GET method (2601). Herein, the query parameters may include a condition for searching UPFs with GPU support feature, such as “NFType=UPF&GPUF=true”.

In response, the NRF may transfer the following message (2603):
2a. 200 OK (SearchResult) if search is successful
2b. 4xx/5xx (ProblemDetails) or 3xx if search is unsuccessful

This search procedure may allow the NF Service Consumer to find a UPF with GPU support capability.

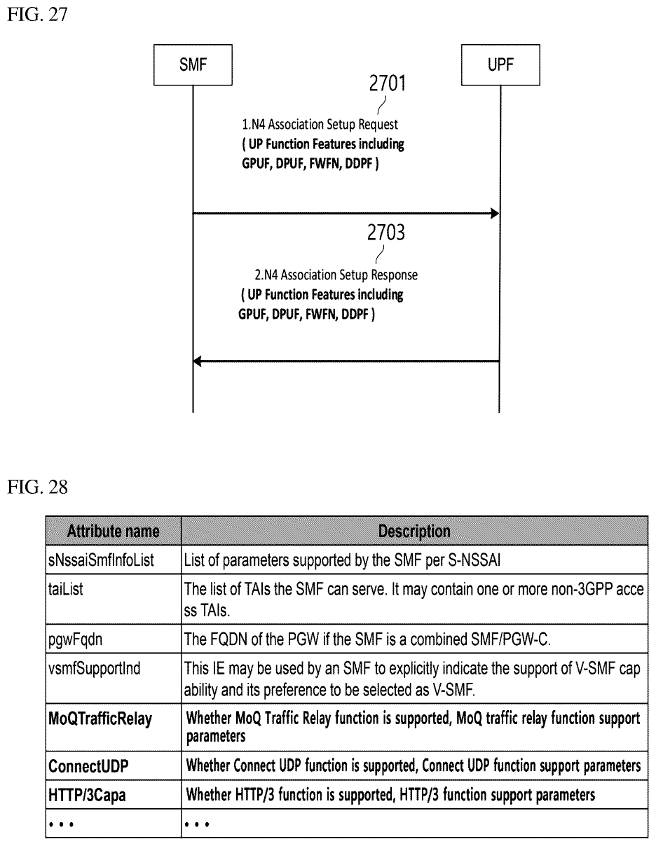

FIG. 27 illustrates an Association Setup procedure of an SMF and a UPF, according to an embodiment of the present disclosure.

Referring to FIG. 27, the procedure of FIG. 27 may proceed in the following order:

(1) The SMF may request UP Function Features including GPU support (GPUF), DPU support (DPUF), firewall support (FWEN), and DDoS protection support (DDPF) from the UPF via an N4 Association Setup Request message (2701).

(2) The UPF may respond to SMF with UP Function Features including GPU support (GPUF), DPU support (DPUF), firewall support (FWEN), and DDoS protection support (DDPF) supported by itself through N4 Association Setup Response message (2703).

Such procedure may allow the SMF to check whether GPU, DPU, firewall, and DDoS protection features supported by the UPF are supported.

According to various embodiments of the present disclosure, a method of providing UPF parameter provisioning in a 5G system includes a step in which a Session Management Function (SMF) receives at least one provisioning parameters of Graphic Procession Unit (GPU) provisioning parameters, Data Procession Unit (DPU) provisioning parameters, Distributed Denial of Service (DDoS) protection provisioning parameters, and Deep Packet Inspection (DPI) provisioning parameters from an Application Function (AF) via a Network Exposure Function (NEF) via a Unified Data Management (UDM) through an SBI interface; and a step in which the SMF retransmits at least one provisioning parameters of GPU provisioning parameters, DPU provisioning parameters, firewall provisioning parameters, Distributed Denial of Service (DDoS) protection provisioning parameters, and Deep Packet Inspection (DPI) provisioning parameters received from the UDM to a User Plane Function (UPF) through a N4 interface.

According to an embodiment, a list of at least one provisioning parameter name is defined, among GPU provisioning parameters, DPU provisioning parameters, Firewall provisioning parameters, Distributed Denial of Service (DDoS) protection provisioning parameters, and Deep Packet Inspection (DPI) provisioning parameters by which the SMF requests the UDM to subscribe for provisioning, and the SBI interface that sends a list of provisioning parameter names that requests the subscription may be Nudm SDM Subscribe service.

According to an embodiment, the SBI interface that transmits and receives at least one provisioning parameter information among GPU provisioning parameters, DPU provisioning parameters, firewall provisioning parameters, Distributed Denial of Service (DDoS) protection provisioning parameters, and Deep Packet Inspection (DPI) provisioning parameters between the AF and the NEF may be the Nnef_ParameterProvision service.

According to an embodiment, the SBI interface that transmits and receives information on the list of names of at least one provisioning parameter among GPU provisioning parameters, DPU provisioning parameters, firewall provisioning parameters, Distributed Denial of Service (DDoS) protection provisioning parameters, and Deep Packet Inspection (DPI) provisioning parameters may be a Nudr_DM_Query service to check whether the provisioning parameters are valid and storable in UDR between the UDM and a Unified Data Repository (UDR).

According to an embodiment, the SBI interface that transmits and receives at least one provisioning parameter information among GPU provisioning parameters, DPU provisioning parameters, firewall provisioning parameters, Distributed Denial of Service (DDoS) protection provisioning parameters, and Deep Packet Inspection (DPI) provisioning parameters between the UDM and the UDR may be a Nudr_DM_Update service.

According to an embodiment, the SBI interface at which at least one provisioning parameter information among GPU provisioning parameters, DPU provisioning parameters, firewall provisioning parameters, Distributed Denial of Service (DDoS) protection provisioning parameters, and Deep Packet Inspection (DPI) provisioning parameters that requests subscription to the UDM between the SMF and the UDM arrives at the UDM and transmits/receives the same to the SMF may be the Nudm_SDM_Notification service.

According to an embodiment, a protocol for exchanging at least one provisioning parameter information of GPU provisioning parameters, DPU provisioning parameters, firewall provisioning parameters, Distributed Denial of Service (DDoS) protection provisioning parameters, and Deep Packet Inspection (DPI) provisioning parameters between the SMF and the UPF may be N4 Packet Forward Control Protocol (PFCP), and may be included in one or more of N4 Session Establishment, N4 Session Modification, or N4 Session Report messages.

According to an embodiment, the GPU provisioning parameters between the AF and the UPF may include one or more among GPU Resource Partitioning, Units Compute Allocation, Memory Allocation, Power States, Clock Speeds, Thermal Limits, Priority Levels, Queue Depth, Preemption Policies, User Permissions, Isolation Policies, Data Encryption, and Tensor Core Usage. Precision Settings, Ray Tracing, Bandwidth Allocation, Data Compression, Direct Memory Access (DMA), Driver Versions, Update Policies, Library Versions, Resource Quotas, Namespace Management, Scheduling Policies, Performance Metrics, Temperature Monitoring, Error Rates, Logging Levels, Alert Thresholds, Notification Methods, Virtual Network Functions (VNFs), Service Chaining, Scaling Policies, Parallel Processing, Load Distribution, Hardware Accelerators, Configuration Settings, Data Caching Policies, Eviction Policy, and Prefetching (FIG. 8).

According to an embodiment, the DPU provisioning parameters between the AF and the UPF may include one or more of Packet Processing Rules, Traffic Shaping, Quality of Service (QoS), Firewall Rules, Encryption Protocols, Intrusion Detection and Prevention, Data Caching Policies, Storage Tiering, Replication and Backup, Resource Allocation, Load Balancing, Acceleration Features, Performance Metrics, Logging Levels, Alert Thresholds, Firmware Updates, Driver Versions, Configuration Profiles, Virtual Network Functions (VNFs), Container Orchestration, Isolation Policies, Interface Speeds, VLAN Tagging, and Multicast Settings (FIG. 16).

According to an embodiment, the firewall provisioning parameters between the AF and the UPF may include one or more of Access Control Lists (ACLs), Network Zones, IP Filtering, Port Filtering, Protocol Filtering, Deep Packet Inspection (DPI), Content Filtering, Connection Tracking, Stateful Rules, Timeout Settings, Intrusion Detection and Prevention, Denial of Service (DOS) Protection, Virtual Network (VPN), Logging, Private Monitoring, Authentication Methods, User Access Policies, Static NAT, Dynamic NAT, Port Address Translation (PAT), Traffic Shaping, Load Balancing, Application Control, URL Filtering, and Firmware and Software Updates (FIG. 17).

According to an embodiment, the DDoS protection provisioning parameters between the AF and the UPF may include one or more of Traffic Monitoring and Analysis, Rate Limiting, Traffic Filtering, Traffic Shaping, Signature-Based Detection, Behavioral Analysis, Automated Responses, Traffic Diversion, On-Premises Scrubbing, Log Management, Reporting, API Integration, Automation, Load Balancing, and Redundancy and Failover (FIG. 18).

According to an embodiment, the DPI provisioning parameters between the AF and the UPF may include one or more of IP and Port Filtering, Protocol Filtering, Header Inspection, Payload Inspection, Application Signatures, Behavior Analysis, Keyword Matching, URL Thresholds and Alerts, Behavioral Filtering, Baselines, Intrusion Detection and Prevention (IDP) Malware and Virus Detection, Traffic Prioritization, Bandwidth Management, Log Retention, Report Generation, SSL/TLS Inspection, Certificate Management, Resource Allocation, Inspection Load Balancing, Signature Updates, and Software Upgrades (FIG. 19).

According to various embodiments of the present disclosure, a method of providing UPF parameter provisioning in a 5G system may include: a step in which a Session Management Function (SMF) receives at least one provisioning parameters of GPU (Graphic Procession Unit) provisioning parameters, DPU (Data Procession Unit) provisioning parameters, Firewall provisioning parameters, Distributed Denial of Service (DDoS) protection provisioning parameters, and DPI (Deep Packet Inspection) provisioning parameters from an Operation Administration Maintenance (OAM) via a Network Repository Function (NRF) through an SBI interface; and a step in which the SMF retransmits at least one provisioning parameter among GPU provisioning parameters, DPU provisioning parameters, Firewall provisioning parameters, Distributed Denial of Service (DDoS) protection provisioning parameters, and Deep

Packet Inspection (DPI) provisioning parameters received from NRF to the User Plane Function (UPF) through the N4 interface.

According to an embodiment, a list of provisioning parameter names is defined, including at least one of GPU provisioning parameters, DPU provisioning parameters, Firewall provisioning Distributed Denial of Service (DDoS) protection parameters, provisioning parameters, and Deep Packet Inspection (DPI) provisioning parameters by which the SMF requests the NRF to subscribe for provisioning, and the SBI interface that transmits the name list of provisioning parameters requesting this subscription may be the Nnrf_NFManagement_NFStatusSubscribe service.

According to an embodiment, the SBI interface that transmits and receives at least one provisioning parameter information among GPU provisioning parameters, DPU provisioning parameters, firewall provisioning parameters, Distributed Denial of Service (DDoS) protection provisioning parameters, and Deep Packet Inspection (DPI) provisioning parameters between SMF and NRF may be the Nnrf_NFManagement_NFStatusNotify service.

According to an embodiment, a protocol used for exchanging at least one provisioning parameters of GPU provisioning parameters, DPU provisioning parameters, firewall provisioning parameters, Distributed Denial of Service (DDoS) protection provisioning parameters, and Deep Packet Inspection (DPI) provisioning parameters between an SMF and a UPF is N4 PFCP (packet Forward Control Protocol), and may be included in one or more of N4 Session Establishment, N4 Session Modification, or N4 Session Report messages.

According to an embodiment, the GPU provisioning parameters between the NRF and the UPF may include one or more among GPU Resource Partitioning, Compute Units Allocation, Memory Allocation, Power States, Clock Speeds, Thermal Limits, Priority Levels, Queue Depth, Preemption Policies, User Permissions, Isolation Policies, Data Encryption, and Tensor Core Usage. Precision Settings, Ray Tracing, Bandwidth Allocation, Data Compression, Direct Memory Access (DMA), Driver Versions, Update Policies, Library Versions, Resource Quotas, Namespace Management, Scheduling Policies, Performance Metrics, Temperature Monitoring, Error Rates, Logging Levels, Alert Thresholds, Notification Methods, Virtual Network Functions (VNFs), Service Chaining, Scaling Policies, Parallel Processing, Load Distribution, Hardware Accelerators, Configuration Settings, Data Caching Policies, Eviction Policy, and Prefetching (FIG. 15).

According to an embodiment, the DPU provisioning parameters between the NRF and the UPF may include one or more of Packet Processing Rules, Traffic Shaping, Quality of Service (QoS), Firewall Rules, Encryption Protocols, Intrusion Detection and Prevention, Data Caching Policies, Storage Tiering, Replication and Backup, Resource Allocation, Load Balancing, Acceleration Features, Performance Metrics, Logging Levels, Alert Thresholds, Firmware Updates, Driver Versions, Configuration Profiles, Virtual Network Functions (VNFs), Container Orchestration, Isolation Policies, Interface Speeds, VLAN Tagging, and Multicast Settings (FIG. 16).

According to an embodiment, the firewall provisioning parameters between the NRF and the UPF may include one or more of Access Control Lists (ACLs), Network Zones, IP Filtering, Port Filtering, Protocol Filtering, Deep Packet Inspection (DPI), Content Filtering, Connection Tracking, Stateful Rules, Timeout Settings, Intrusion Detection and Prevention, Denial of Service Private Network (VPN), Logging, (DOS) Protection, Virtual Monitoring, Authentication Methods, User Access Policies, Static NAT, Dynamic NAT, Port Address Translation (PAT), Traffic Shaping, Load Balancing, Application Control, URL Filtering, and Firmware and Software Updates (FIG. 17).

According to an embodiment, the DDoS protection provisioning parameters between the NRF and the UPF may include one or more of Traffic Monitoring and Analysis, Rate Limiting, Traffic Filtering, Traffic Shaping, Signature-Based Detection, Behavioral Analysis, Automated Responses, Traffic Diversion, On-Premises Scrubbing, Log Management, Reporting, API Integration, Automation, Load Balancing, and Redundancy and Failover (FIG. 18).

According to an embodiment, the DPI provisioning parameters between the NRF and the UPF may include one or more of IP and Port Filtering, Protocol Filtering, Header Inspection, Payload Inspection, Application Signatures, Behavior Analysis, Keyword Matching, URL Filtering, Thresholds and Alerts, Behavioral Baselines, Intrusion Detection and Prevention (IDP) Malware and Virus Detection, Traffic Prioritization, Bandwidth Management, Log Retention, Report Generation, SSL/TLS Inspection, Certificate Management, Resource Allocation, Inspection Load Balancing, Signature Updates, and Software Upgrades (FIG. 19).

According to various embodiments of the present disclosure, a method of providing UPF parameter provisioning in a 5G system may include a step in which a User Pane Function (UPF) with GPU, DPU, firewall, and DDoS protection support features registers GPU, DPU, firewall, and DDoS protection support information to an Network Repository Function (NRF) through an Service Based Interface (SBI) interface; and a step in which a Network Function (NF) searches the NRF for the UPF with GPU, DPU, firewall, and DDoS protection support information through an SBI interface.

According to an embodiment, an SBI interface used by a UPF with GPU, DPU, firewall, and DDoS protection support features to register at least one Feature of GPU Support Feature (GPUF), DPU Support Feature (DPUF), Firewall Protection Support Feature (FWEN), and DDoS Protection Support Feature (DDPF) to an NRF is Nnrf_NFManagement_Register Request or Nnrf_NFManagement_Update Request service, and may include a GPU Support Feature (GPUF), a DPU Support Feature (DPUF), a Firewall Protection Support Feature (FWEN), and a DDoS Protection Support Feature (DDPF) as supportedPfcpFeatures: UP Function Features included in this service.

According to an embodiment, an SBI interface used by a Network Function (NF) to search an NRF for a UPF including at least one Feature of a GPU Support Feature (GPUF), a DPU Support Feature (DPUF), a Firewall Protection Support Feature (FWFN), and a DDoS Protection Support Feature (DDPF) through the SBI interface is the Nnrf_NFDiscovery NFDiscover service, and query parameters included in this service may include at least one Feature of UP Function Features including the GPU Support Feature (GPUF), the DPU Support Feature (DPUF), the Firewall Protection Support Feature (FWEN), and the DDoS Protection Support Feature (DDPF).

According to an embodiment, the existing UP Function Features may include UP Function Features (FIG. 21) including a GPU Support Feature (GPUF), a DPU Support Feature (DPUF), a Firewall Protection Support Feature (FWEN), and a DDoS Protection Support Feature (DDPF).

According to various embodiments of the present disclosure, a method of providing UPF parameter provisioning in a 5G system may include a step in which a Session Management Function (SMF) checks whether a UPF includes at least one feature of a GPU Support Feature (GPUF), a DPU Support Feature (DPUF), a Firewall Protection Support Feature (FWEN), and a DDoS Protection Support Feature (DDPF) in the Association Setup procedure with the UPF through the N4 interface.

According to an embodiment of the present disclosure, a protocol used to exchange between an SMF and a UFP to check whether UP Function Features include a GPU Support Feature (GPUF), a DPU Support Feature (DPUF), a Firewall Protection Support Feature (FWEN), and a DDoS Protection Support Feature (DDPF) is a N4 packet Forward Control Protocol (PFCP), and an N4 Association Setup Request and an N4 Association Setup Response messages, and may include at least one feature of a GPU Support Feature (GPUF), a DPU Support Feature (DPUF), a Firewall Protection Support Feature (FWEN), and a DDoS Protection Support Feature (DDPF) as UP Function Features included in this message.

FIG. 28 illustrates detailed attributes of MoQ traffic Relay support function, Connect-UDP support function, and HTTP/3 support function included in smfInfo that SMF registers with NRF, according to an embodiment of the present disclosure.

Referring to FIG. 28, smfInfo may include new attributes along with existing attributes as following:

(1) Existing attributes:
sNssaiSmfInfoList: A list of parameters supported by SMF per S-NSSAI may be contained.
taiList: The list of TAIs the SMF may serve may be contained. It may contain one or more non-3GPP access TAIs.
pgwFqdn: The FQDN of the PGW may be contained if the SMF is a combined SMF/PGW-C.
vsmfSupportInd: This IE may be used by the SMF to explicitly indicate the support of the V-SMF capability and its preference to be selected as V-SMF.

(2) Newly added attributes:
MoQTrafficRelay: Information on whether MoQ Traffic Relay function is supported, and related parameters may be contained.
ConnectUDP: Information on whether Connect UDP function is supported, and related parameters may be contained.
HTTP3Capa: Information on whether HTTP/3 function is supported, and related parameters may be contained.

This information may be used to register XRM service-related functions supported by the SMF to the NRF.

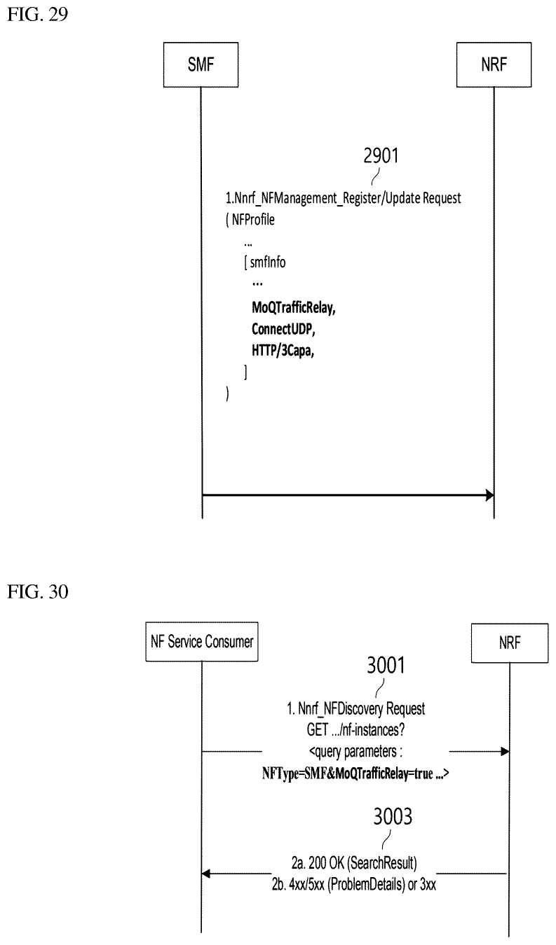

FIG. 29 illustrates a procedure in which a SMF registers with a NRF, including MoQ traffic Relay support function, Connect-UDP support function, and HTTP/3 support function, according to an embodiment of the present disclosure.

Referring to FIG. 29, a procedure in which the SMF registers XRM service-related functions to NRF may be illustrated.

The SMF may transfer Nnrf_NFManagement_Register Request or Nnrf_NFManagement_Update Request message to the NRF (2901). This message may include NFProfile information, and smfInfo in the NFProfile may include the following functions:
MoQTrafficRelay: MOQ traffic relay function support information
ConnectUDP: Connect UDP function support information
HTTP/3Capa: HTTP/3 function support information

This registration procedure may allow the SMF to register the XRM service-related functions supported by itself to the NRF.

FIG. 30 illustrates a procedure in which an NF Service Consumer searches the NRF for an SMF with a MoQ traffic Relay support function, according to an embodiment of the present disclosure.

Referring to FIG. 30, a procedure in which the NF Service Consumer searches the NRF for an SMF with a MoQ traffic Relay support function may be illustrated.

The NF Service Consumer may transfer NRF Nnrf_NFDiscovery Request service via GET method (3001). Herein, query parameters may include conditions for searching SMFs supporting MoQ traffic relay function in the form of “NFType=SMF&MoQTrafficRelay=true”.

The NRF may send the following message in response (3003):
2a. 200 OK (SearchResult) if search is successful
2b. 4xx/5xx (ProblemDetails) or 3xx if search is unsuccessful

This search procedure may allow the NF Service Consumer to find an SMF that supports the MoQ traffic relay function.

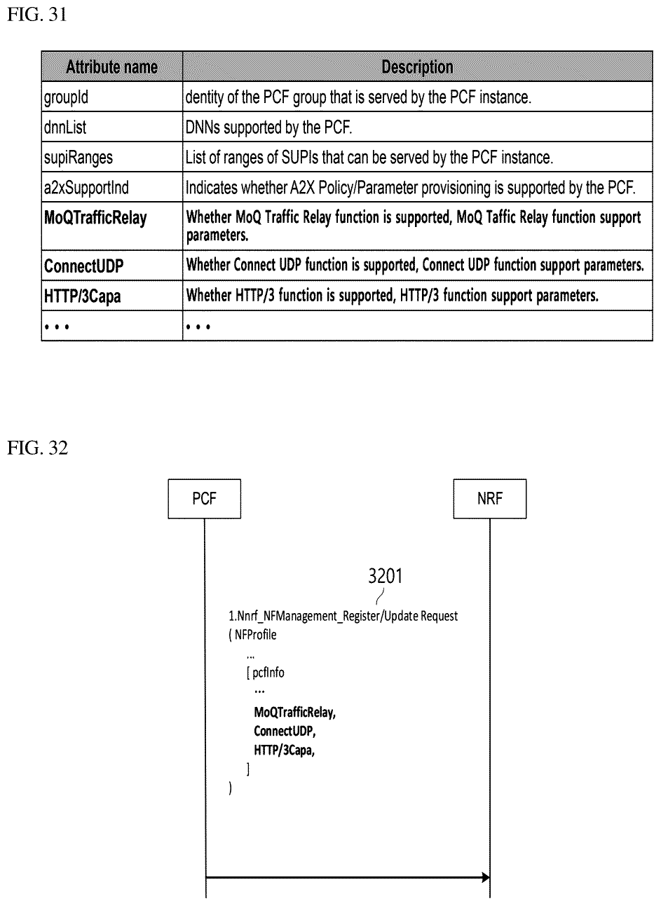

FIG. 31 illustrates detailed attributes of the MoQ traffic

Relay support function, Connect-UDP support function, and HTTP/3 support function included in pcfInfo that a PCF registers with NRF, according to an embodiment of the present disclosure. Referring to FIG. 31, pcfInfo may include new attributes along with existing attributes as following:

(1) Existing attributes:
groupId: Identity of the PCF group that is served by the PCF instance may be contained.
dnnList: DNNs supported by the PCF may be contained.
supiRanges: A list of ranges of SUPIs that may be served by the PCF instance may be contained.
a2×SupportInd: Indicate whether A2X Policy/Parameter provisioning is supported by the PCF.

(2) Newly added attributes:
MoQTrafficRelay: Information on whether MoQ Traffic Relay function is supported, and related parameters may be contained.
ConnectUDP: Information on whether Connect UDP function is supported, and related parameters may be contained.
HTTP3Capa: Information on whether HTTP/3 function is supported, and related parameters may be contained.

This information may be used to register XRM service-related functions supported by the PCF to the NRF.

FIG. 32 illustrates a procedure in which PCF registers with NRF, including MoQ traffic Relay support function, Connect-UDP support function, and HTTP/3 support function, according to an embodiment of the present disclosure.

Referring to FIG. 32, a procedure in which the PCF registers XRM service-related functions to NRF may be illustrated.

The PCF may transfer Nnrf_NFManagement_Register Request or Nnrf_NFManagement_Update Request message to the NRF (3201). This message may include NFProfile information, and pcfInfo in NFProfile may include the following functions:
MoQTrafficRelay: MOQ traffic relay function Support Information
ConnectUDP: Connect UDP function Support information
HTTP/3Capa: HTTP/3 function support information

Such registration procedure may allow the PCF to register the XRM service-related functions supported by itself to the NRF.

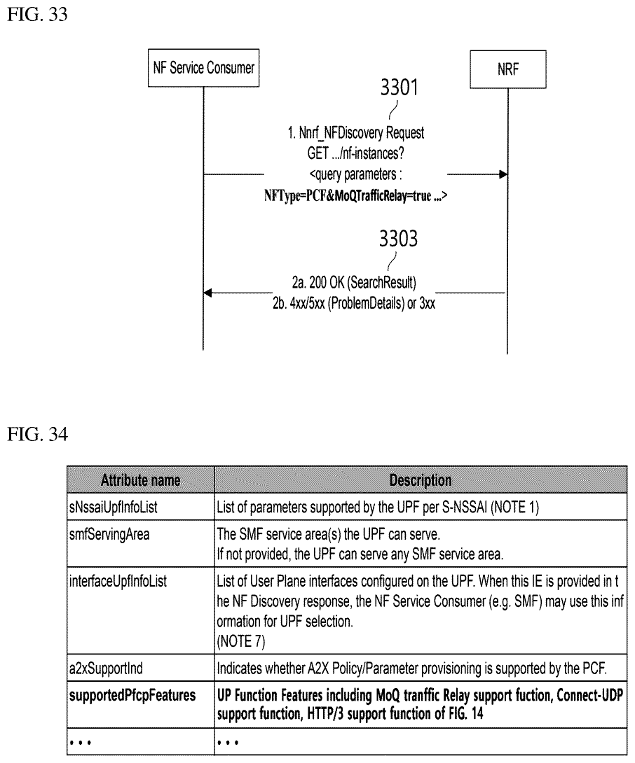

FIG. 33 illustrates a procedure in which an NF Service Consumer searches a NRF for a PCF with MoQ Traffic Relay support function, according to an embodiment of the present disclosure.

Referring to FIG. 33, a procedure in which an NF Service Consumer searches a NRF for a PCF with MoQ Traffic Relay support function may be illustrated.

The NF Service Consumer may transfer Nnrf_NFDiscovery Request service to NRF via GET method (3301). Herein, query parameters may include conditions for searching PCF supporting MoQ traffic relay function in the form of “NFType=PCF&MoQTrafficRelay=true”.

The NRF may transfer the following messages in response (3303):
2a. 200 OK (SearchResult) if search is successful
2b. 4xx/5xx (ProblemDetails) or 3xx if search is unsuccessful

This search procedure may allow the NF Service Consumer to find the PCF supporting MoQ traffic relay function.

FIG. 34 illustrates detailed attributes of MoQ traffic Relay support function, Connect-UDP support function, and HTTP/3 support function included in upfInfo registered by the UPF to NRF, according to an embodiment of the present disclosure.

Referring to FIG. 34, upfInfo may include new attributes along with the existing attributes as following:

(1) Existing attributes:
sNssaiUpfInfoList: A list of parameters supported by UPF per S-NSSAI may be contained.
smfServingArea: The SMF service area the UPF may serve may be defined. When not provided, the UPF may serve any SMF service areas.
interfaceUpfInfoList: A list of user plane interfaces configured on the UPF. When this information is provided in the NF Discovery response, the NF Service Consumer (e.g., SMF) may use this information for UPF selection.
a2×SupportInd: Indicate whether A2X Policy/Parameter provisioning is supported by the PCF.

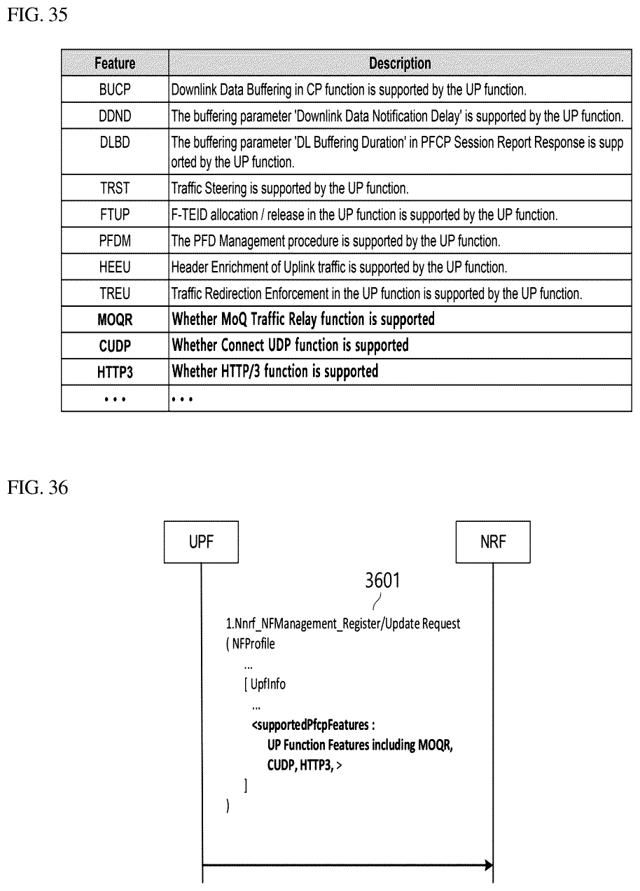

(2) Newly added attributes:
supportedPfcpFeatures: UP Function Features including a MoQ traffic Relay support function, a Connect UDP support feature, and HTTP/3 support function defined in FIG. 35 may be represented. This information may be used to register XRM service-related functions supported by UPF to NRF.

FIG. 35 illustrates UP Function Features including MoQ traffic Relay support function, Connect-UDP support function, and HTTP/3 support function Feature included in supportedPfcpFeatures of FIG. 34, according to an embodiment of the present disclosure.

Referring to FIG. 35, a form in which new functions are added to existing UP Function Features may be illustrated.

(1) Existing UP Function Features may include the following functions:
BUCP: Downlink data buffering in CP function is supported by the UP function.
DDND: The buffering parameter “Downlink Data Notification Delay: is supported by the UP function.
DLBD: The buffering parameter “DL Buffering Duration in PFCP Session Report Response is supported by the UP function.
TRST: Traffic steering is supported by the UP function.
FTUP: F-TEID allocation and release in the UP function is supported by the UP function.
PFDM: The PFD management procedure is supported by the UP function.
HEEU: Header reinforcement of uplink traffic is supported by the UP function.
TREU: Traffic redirection Enforcement in the UP function is supported by the UP function.

(2) The newly added functions are as follows:
MOOR: Whether MoQ traffic relay function is supported
CUDP: Whether Connect-UDP function is supported
HTTP3: Whether HTTP/3 function is supported

Such UP Function Features may be used as the supportedPfcpFeatures attribute in upfInfo of FIG. 34.

FIG. 36 illustrates a procedure in which a UPF registers with a NRF, including MoQ traffic Relay support function, Connect-UDP support function, and HTTP/3 support function, according to an embodiment of the present disclosure.

Referring to FIG. 36, a procedure in which the UPF registers XRM service-related functions to NRF may be illustrated.

The UPF may transfer NRF an Nnrf_NFManagement_Register Request or Nnrf_NFManagement_Update Request message (3601). This message may include NFProfile information, and UpfInfo in NFProfile may include the following functions as the supportedPfcpFeatures attribute:
MOQR: MoQ traffic Relay support function
CUDP: Connect-UDP support function
HTTP3: HTTP/3 support function

Such registration procedure may allow the UPF to register the XRM service-related functions supported by itself with the NRF.

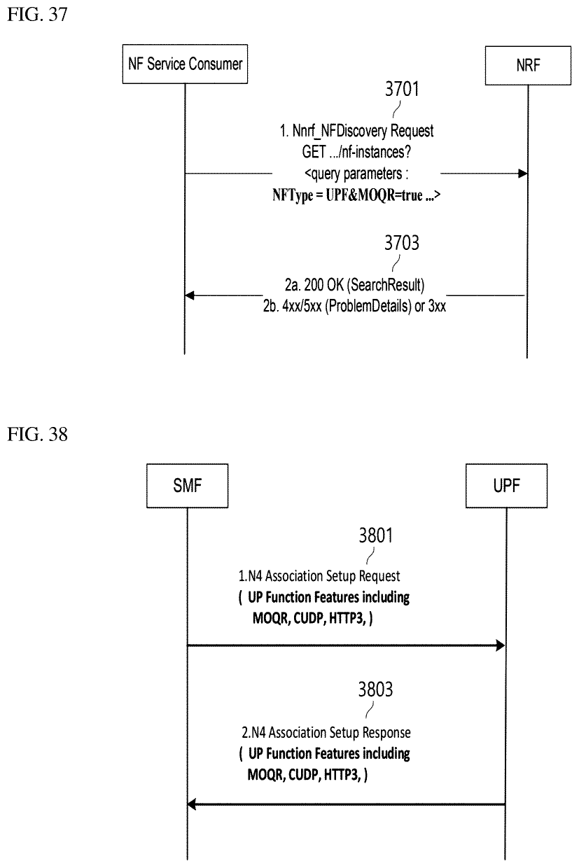

FIG. 37 illustrates a procedure in which an NF Service Consumer searches a NRF for a UPF with MoQ traffic Relay support function, according to an embodiment of the present disclosure.

Referring to FIG. 37, a procedure in which an NF Service Consumer search a NRF for a UPF with MoQ traffic Relay support function may be illustrated.

The NF Service Consumer may transmit an Nnrf_NFDiscovery Request service to the NRF via a GET method (3701). Herein, query parameters may include a condition for searching for a UPF supporting the MoQ traffic relay function in the form of “NFType=UPF&MOOR=true”.

The NRF may transmit the following message in response (3703):
2a. 200 OK (SearchResult) if search is successful
2b. 4xx/5xx (ProblemDetails) or 3xx if search is unsuccessful

This search procedure may allow the NF Service Consumer to find a UPF that supports the MoQ traffic relay function.

FIG. 38 illustrates a procedure in which a UPF provides UP Function Features including MoQ traffic Relay support function, Connect-UDP support function, and HTTP/3 support function Features to a SMF in an Association Setup procedure of the SMF and the UPF, according to an embodiment of the present disclosure.

Referring to FIG. 38, the Association Setup procedure of the SMF and the UPF may be illustrated.

The procedure of FIG. 38 may be performed in the following order:

(1) The SMF may request UP Function Features including MoQ Traffic Relay support function (MOOR), Connect-UDP support function (CUDP), and HTTP/3 support function (HTTP3) from the UPF through a N4 Association Setup Request message (3801).

(2) The UPF may respond to the SMF the UP Function Features including MoQ Traffic Relay support function (MOQR), Connect-UDP support function (CUDP), and HTTP/3 support function (HTTP3) supported by itself through N4 Association Setup Response message (3803).

Such procedure may allow the SMF to check whether the UPF supports XRM service-related functions.

According to various embodiments of the present disclosure, a method of providing XRM function information in a 5G system may include a step in which a Session Management Function (SMF) having MoQ traffic Relay support function, Connect-UDP support function, and HTTP/3 support function registers information about MoQ traffic Relay support function, Connect-UDP support function, and HTTP/3 support function to a Network Repository Function (NRF) through a Service Based Interface (SBI) interface; a step in which a Network Function (NF) searches the NRF for the SMF including the information about the MoQ traffic Relay support function, the Connect-UDP support function, and the HTTP/3 support function through the SBI interface.

According to an embodiment, an SMF having MoQ traffic Relay support function, Connect-UDP support function, and HTTP/3 support function may include smfInfo information (FIG. 28) including MoQTrafficRelay, ConnectUDP, and HTTP/3Capa, which are MoQ traffic Relay support functions, Connect-UDP support function, and HTTP/3 support function attributes.

According to an embodiment, an SBI interface used by an SMF having MoQ traffic Relay support function, Connect-UDP support function, and HTTP/3 support function to register, to an NRF, smfInfo information including MoQTrafficRelay, ConnectUDP, and HTTP/3Capa, which are MoQ traffic Relay support functions, Connect-UDP support function, and HTTP/3 support function attributes may be a Nnrf_NFManagement_Register Request service or a Nnrf_NFManagement_Update Request service.

According to an embodiment, a SBI interface used by a Network Function (NF) to search a NRF for an SMF including a MoQ traffic Relay support function, a Connect-UDP support function, and an HTTP/3 support function through an SBI interface is a Nnrf_NFDiscovery Request service, and the query parameters included in this service may include at least one of MoQTrafficRelay, ConnectUDP, and HTTP/3Capa, which are MoQ traffic Relay support functions, Connect-UDP support function, and HTTP/3 support function attributes.

According to various embodiments of the present disclosure, a method of providing XRM function information in a 5G system includes a step in which a Policy Control Function (PCF) having MoQ traffic Relay support function, Connect-UDP support function, and HTTP/3 support function registers information on the MoQ traffic Relay support function, the Connect-UDP support function, and the HTTP/3 support function to an Network Repository Function (NRF) through an SBI (Service Based Interface) interface; and a step in which a Network Function (NF) searches the NRF for the SMF including MoQ traffic Relay support function, Connect-UDP support function, and HTTP/3 support function information through SBI interface.

According to an embodiment, a PCF having MoQ traffic Relay support function, Connect-UDP support function, and HTTP/3 support function may include pcfInfo information (FIG. 31) including MoQTrafficRelay, ConnectUDP, and HTTP/3Capa, which are MoQ traffic Relay support functions, Connect-UDP support function, and HTTP/3 support function attributes.

According to an embodiment, a SBI interface used by a PCF having MoQ traffic Relay support function, Connect-UDP support function, and HTTP/3 support function to register, to an NRF, pcfInfo information including MoQTrafficRelay, ConnectUDP, and HTTP/3Capa, which are MoQ traffic Relay support functions, Connect-UDP support function, and HTTP/3 support function attributes may be a Nnrf_NFManagement_Register Request service or a Nnrf_NFManagement_Update Request service.

According to an embodiment, a SBI interface used by a Network Function (NF) to search an NRF for a PCF including a MoQ traffic Relay support function, a Connect-UDP support function, and an HTTP/3 support function through an SBI interface is a Nnrf_NFDiscovery Request service, and the query parameters included in this service may include at least one of MoQTrafficRelay, ConnectUDP, and HTTP/3Capa, which are MOQ traffic Relay support functions, Connect-UDP support function, and HTTP/3 support function attributes.

According to various embodiments of the present disclosure, a method of providing XRM function information in a 5G system may include a step in which a User Plane Function (UPF) having a MoQ traffic Relay support function, a Connect-UDP support function, and an HTTP/3 support function registers information on the MoQ traffic Relay support function, the Connect-UDP support function, and the HTTP/3 support function to an Network Repository Function (NRF) through a Service Based Interface (SBI) interface; and a step in which a Network Function (NF) searches a NRF for a UPF including MoQ traffic Relay support function, Connect-UDP support function, and HTTP/3 support function information through a SBI interface.

According to an embodiment, a UPF with MoQ Traffic Relay support function, Connect-UDP support function, and HTTP/3 support function may include upfInfo information (FIG. 34) that includes UP Function Features, including MOQ Traffic Relay support function, Connect-UDP support function, and HTTP/3 support function, which are MoQ traffic Relay support functions, Connect-UDP support function, HTTP/3 support function attributes.

According to an embodiment, the existing Up Function Features may include UP Function Features (FIG. 35) including whether MoQ Traffic Relay function is supported, whether Connect-UDP function is supported, and whether HTTP/3 function is supported, which are MOQ Traffic Relay support functions, Connect-UDP support function, and HTTP/3 support function Features.

According to an embodiment, a SBI interface used by a Network Function (NF) to search a NRF for a UPF including a MoQ traffic Relay support function, a Connect-UDP support function, and an HTTP/3 support function through SBI the interface is a Nnrf_NFDiscovery Request service, and the query parameters included in this service may include at least one of whether MoQ traffic relay function is supported (MOQR), whether Connect-UDP function is supported (CUDP), and whether HTTP/3 function is supported (HTTP3), which are MoQ traffic Relay support functions, Connect-UDP support function, and HTTP/3 support function Attributes.

According to various embodiments of the present disclosure, a method of providing XRM function information in a 5G system may include a step in which a Session Management Function (SMF) checks whether a UPF includes MoQ traffic Relay support function, Connect-UDP support function, and HTTP/3 support function Features in an Association Setup procedure along with a UPF through an N4 interface.

According to an embodiment, a protocol used to exchange between the SMF and the UPF to check whether it includes Features of whether MoQ Traffic Relay function is Supported (MOQR), whether Connect-UDP function is supported (CUDP), whether HTTP/3 function is supported (HTTP3), which are MoQ Traffic Relay support functions, Connect-UDP support function, HTTP/3 support function attributes, is N4 Association Setup Request, N4 Association Setup Response message of N4 PFCP (packet Forward Control Protocol), and may include MoQ Traffic Relay Feature Support (MOQR), Connect-UDP Feature Support (CUDP), HTTP/3 Feature Support (HTTP3) Features, which are UP Function Features including MoQ Traffic Relay support function, Connect-UDP support function, and HTTP/3 support function included in this message.

According to an embodiment, the existing UP Function Features may include Features of whether MoQ Traffic Relay function is supported (MOQR), whether Connect-UDP function is supported (CUDP), and whether HTTP/3 function is supported (HTTP3).

According to an embodiment, the UPF may have the MoQ Traffic Relay support function, the Connect-UDP support function, and the HTTP/3 support function.

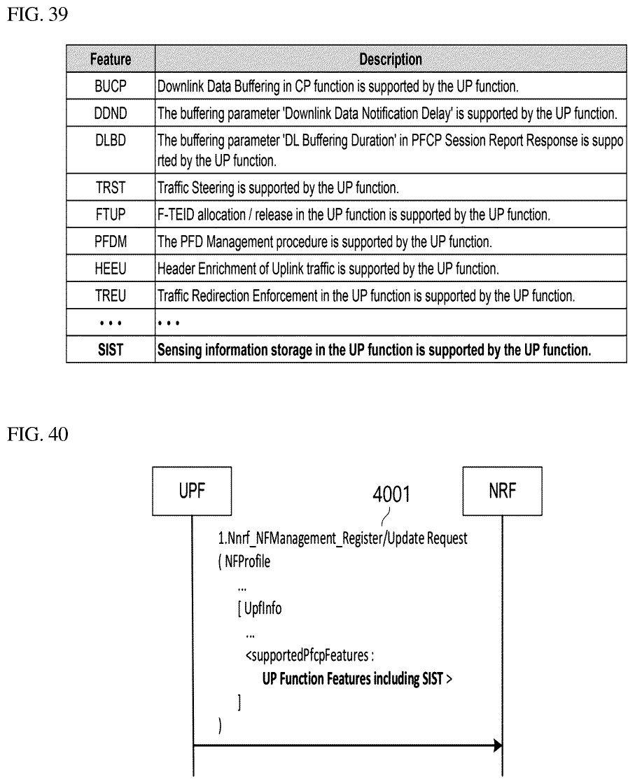

FIG. 39 illustrates a table in which sensing information storage Feature is added to the existing UP Function Features, according to an embodiment of the present disclosure.

Referring to FIG. 39, UP Function Features may include new features along with existing features.

(1) Existing UP Function Features may include the following features:
BUCP: Downlink data buffering in CP function is supported by the UP function.
DDND: The buffering parameter “downlink data notification delay” is supported by the UP function.
DLBD: The buffering parameter “Downlink buffering duration” in PFCP Session Report Response is supported by the UP function.
TRST: Traffic steering is supported by the UP function.
FTUP: F-TEID allocation and release in UP function is supported by the UP function.
PFDM: The PFD management procedure in UP function is supported by the UP function.
HEEU: Header reinforcement of uplink traffic is supported by the UP function.
TREU: Traffic redirection Enforcement in the UP function is supported by the UP function.

(2) The newly added functions are as follows:
Sensing Information Storage (SIST): Sensing information storage in the UP function is supported by the UP function. Such UP Function Features may be used to register functions supported by the UPF to the NRF and to be searched by other network functions.

FIG. 40 illustrates a procedure in which a UPF including sensing information storage feature registers with an NRF, according to an embodiment of the present disclosure.

Referring to FIG. 40, a procedure in which a UPF registers sensing information storage feature to an NRF may be illustrated.

The UPF may transmit Nnrf_NFManagement_Register Request or Nnrf_NFManagement_Update Request message to the NRF (4001). This message may contain NFProfile information, and UpfInfo within the NFProfile may contain UP Function Features including the Sensing Information Storage Feature (SIST) defined in FIG. 39 as supportedPfcpFeatures attributes.

This registration procedure may allow the UPF to be registered to the NRF that it supports the sensing information storage feature.

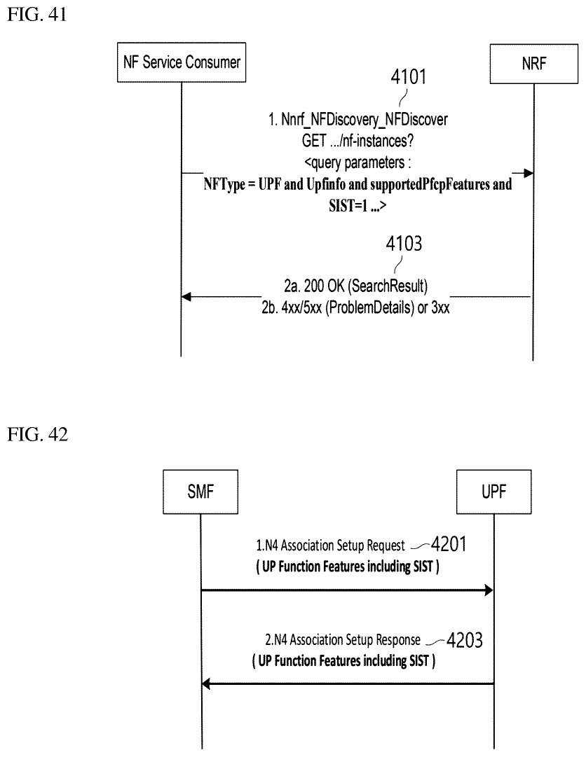

FIG. 41 illustrates a procedure in which an NF Service Consumer searches for a UPF with a sensing information storage feature in the NRF, according to an embodiment of the present disclosure.

Referring to FIG. 41, a procedure in which an NF Service Consumer searches for a UPF with a sensing information storage feature in a NRF may be illustrated.

The NF Service Consumer may transmit an Nnrf_NFDiscovery

Request service to the NRF via a GET method (4101). Herein, the query parameters may include a condition for searching for a UPF with a sensing information storage feature in the form of “NFType-UPF and UpfInfo and supportedPfcpFeatures and SIST=1”.

In response, the NRF may transmit the following message (4103):

2a. 200 OK (SearchResult) if search is successful

2b. 4xx/5xx (ProblemDetails) or 3xx if search is unsuccessful

This search procedure may allow the NF Service Consumer to find a UPF that supports the sensing information storage feature.

FIG. 42 illustrates a procedure in which a UPF provides UP Function Features including the sensing information storage Feature to the SMF in an Association Setup procedure of an SMF and a UPF, according to an embodiment of the present disclosure.

Referring to FIG. 42, an Association Setup procedure of an SMF and a UPF may be illustrated.

The procedure of FIG. 42 may be performed in the following order:

(1) The SMF may request UP Function Features including a sensing information storage Feature (SIST) from the UPF for through an N4 Association Setup Request message (4201).

(2) The UPF may respond to the SMF with UP Function Features including a sensing information storage feature (SIST) supported by itself through N4 Association Setup Response message (4203).

This procedure may allow the SMF to check whether to support the sensing information storage feature supported by the UPF.

According to various embodiments of the present disclosure, a method of providing UPF functionality information in a 5G system may include a step in which a User Pane Function (UPF) having sensing information storage feature registers a sensing information storage Feature (SIST) to a Network Repository Function (NRF) through a Service Based Interface (SBI) interface; a step in which a Network Function (NF) searches the NRF for the UPF including a sensing information storage Feature (SIST) through an SBI interface;

According to an embodiment, an SBI interface used by a UPF having a sensing information storage feature to register a sensing information storage Feature (SIST) to an NRF is a Nnrf_NFManagement_Register Request or Nnrf_NFManagement_Update Request service, and may include a sensing information storage Feature (SIST) as supportedPfcpFeatures: UP Function Feature in included in this service.

According to an embodiment, the SBI interface used by a Network Function (NF) to search a NRF for a UPF including sensing information storage Feature (SIST) through the SBI interface is the Nnrf_NFDiscovery NFDiscover service, and may include sensing information storage Feature (SIST) of UP Function Features in query parameters included in this service.

According to an embodiment, the sensing information storage Feature (SIST) may be included in the existing UP Function Features.

According to various embodiments of the present disclosure, a method of providing UPF functionality information in a 5G system may include a step of checking whether the UPF includes a sensing information storage Feature (SIST) in UP Function Features in an Association Setup procedure along with the UPF through the N4 interface by a Session Management Function (SMF).

According to an embodiment, a protocol used to exchange between a SMF and a UPF to check whether UP Function Features include a sensing information storage feature (SIST) is a packet Forward Control Protocol (N4 PFCP) and N4 Association Setup Request and N4 Association Setup Response messages, and may include a sensing information storage feature (SIST) UP Function Features included in this message.

According to an embodiment, the sensing information storage feature (SIST) may be included in existing UP Function Features.

According to an embodiment, the UPF may have a sensing information storage feature according to requests from the SMF.

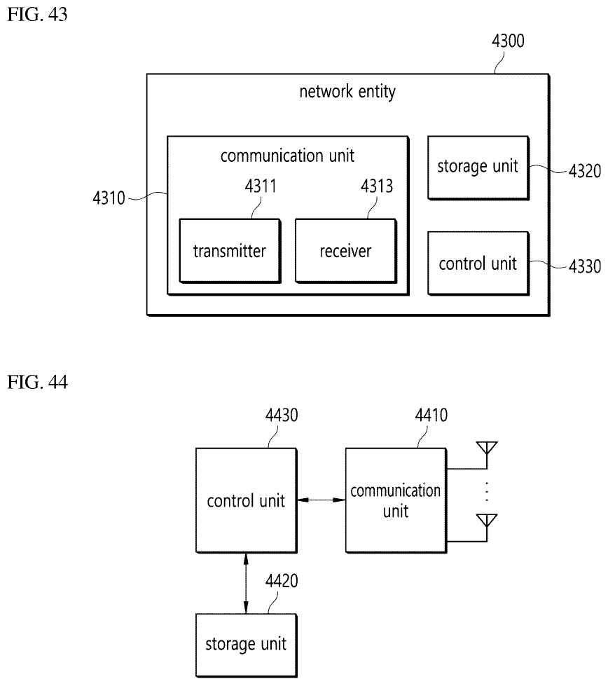

FIG. 43 illustrates a configuration of a network entity in a wireless communication system according to various embodiments of the present disclosure. The network entity of the present disclosure is a concept that includes a network function according to the system implementation. The terms “part”, “unit”, etc. used below mean a unit that processes at least one function or operation, which may be implemented by hardware or software, or a combination of hardware and software.

A network entity 4300 according to various embodiments of the present disclosure may include a communication unit 4310, a storage unit 4320, and a control unit 4330 that controls overall operation of the network entity 4300. The communication unit 4310 transmits and receives signals with other network entities. Accordingly, all or part of the communication unit 4310 may be referred to as a “transmitter” 4311, a “receiver” 4313, or a “transceiver” 4310. The storage unit 4320 stores data such as a basic program, an application program, and setting information for the operation of the network entity 4300. The storage unit 4320 may be composed of volatile memory, nonvolatile memory, or a combination of volatile memory and nonvolatile memory. In addition, the storage unit 4320 provides stored data according to a request of the control unit 4330. The control unit 4330 controls overall operations of the network entity 4300. For example, the control unit 4330 transmits and receives signals through the communication unit 4310. In addition, the control unit 4330 records and reads data in the storage unit 4320. In addition, the control unit 4330 may perform functions of a protocol stack required by a communication standard. For this purpose, the control unit 4330 may include a circuit, an application-specific circuit, at least one processor or microprocessor, or may be a part of a processor. In addition, a part of the communication unit 4310 and the control unit 4330 may be referred to as a communication processor (CP). The control unit 4330 may control the network entity 4300 to perform any one of the various embodiments of the present disclosure. The communication unit 4310 and the control unit 4330 do not necessarily have to be implemented as separate modules, and may of course be implemented as a single component in the form of a single chip or software block. The communication unit 4310, the storage unit 4320, and the control unit 4330 may be electrically connected. In addition, the operations of the network entity 4300 may be realized by providing a storage unit 4320 storing the corresponding program code within the network entity 4300. A network entity 4300 includes a network node, and may be any one of a base station (RAN), NSSF, EASDF, NSCAF, AMF, SMF, UPF, NF, NEF, NRF, CF, NSSF, UDM, AF, AUSF, SCP, UDSF, DN, (R)AN, context storage, OAM, EMS, configuration server, and identifier management server.

FIG. 44 illustrates a configuration diagram of a terminal in a wireless communication system, according to various embodiments of the present disclosure. The configuration illustrated in FIG. 44 may be understood as a configuration of a terminal. The terms “ . . . unit”, “ . . . unit”, etc. used below mean a unit that processes at least one function or operation, which may be implemented by hardware or software, or a combination of hardware and software.

Referring to FIG. 44, the terminal may include a communication unit 4410, a storage unit 4420, and a control unit 4430.

The communication unit 4410 may perform functions for transmitting and receiving signals through a wireless channel. For example, the communication unit 4410 may perform a conversion function between a baseband signal and a bit stream according to physical layer specifications of the system. For example, when transmitting data, the communication unit 4410 may generate complex symbols by encoding and modulating a transmission bit stream. When receiving data, the communication unit 4410 may restore a reception bit stream by demodulating and decoding a baseband signal. In addition, the communication unit 4410 may up-convert a baseband signal into an RF band signal and then transmit it through an antenna, and down-convert an RF band signal received through the antenna into a baseband signal. For example, the communication unit 4410 may include a transmission filter, a reception filter, an amplifier, a mixer, an oscillator, a DAC, an ADC, etc.

In addition, the communication unit 4410 may include a plurality of transmit/receive paths. In addition, the communication unit 4410 may include at least one antenna array composed of a plurality of antenna elements. In terms of hardware, the communication unit 4410 may be composed of digital circuits and analog circuits (e.g., radio frequency integrated circuits (RFIC)). Here, the digital circuits and analog circuits may be implemented in one package. In addition, the communication unit 4410 may include a plurality of RF chains. In addition, the communication unit 4410 may perform beamforming.

The communication unit 4410 transmits and receives signals as described above. Accordingly, all or part of the communication unit 4410 may be referred to as a “transmitter”, a “receiver” or a “transceiver”. In addition, in the following description, transmission and reception performed through a wireless channel may be used to mean that processing as described above is performed by the communication unit 4410.

The storage unit 4420 may store data such as a basic program, an application program, and setting information for the operation of the terminal. The storage unit 4420 may be composed of a volatile memory, a nonvolatile memory, or a combination of a volatile memory and a nonvolatile memory. In addition, the storage unit 4420 may provide stored data upon a request from the control unit 4430.

The control unit 4430 may control the overall operations of the terminal. For example, the control unit 4430 may transmit and receive signals through the communication unit 4410. In addition, the control unit 4430 may record and read data in the storage unit 4420. The control unit 4430 may perform functions of the protocol stack required by the communication standard. To this end, the control unit 4430 may include at least one processor or microprocessor, or may be a part of the processor. In addition, a part of the communication unit 4410 and the control unit 4430 may be referred to as a communication processor (CP).

According to various embodiments, the control unit 4430 may control the terminal to perform operations according to various embodiments described above.

The methods according to the embodiments described in the claims or specification of the present disclosure may be implemented in the form of hardware, software, or a combination of hardware and software.

In the case of software implementation, a computer-readable storage medium storing one or more programs (software modules) may be provided. The one or more programs stored in the computer-readable storage medium are configured for execution by one or more processors in an electronic device. The one or more programs include instructions that cause the electronic device to execute the methods according to the embodiments described in the claims or specification of the present disclosure.

These programs (software modules, software) may be stored in random access memory, non-volatile memory including flash memory, read only memory (ROM), electrically erasable programmable read only memory (EEPROM), magnetic disc storage devices, compact disc-ROMS (CD-ROM), digital versatile discs (DVDs) or other forms of optical storage devices, magnetic cassettes. Alternatively, they may be stored in a memory composed of a combination of some or all of them. In addition, multiple configuration memories may exist.

In addition, the program may be stored on an attachable storage device that is accessible via a communications network, such as the Internet, an intranet, a local area network (LAN), a wide area network (WAN), or a storage area network (SAN), or a combination thereof. The storage device may be connected to a device performing an embodiment of the present disclosure via an external port. In addition, a separate storage device on the communications network may be connected to a device performing an embodiment of the present disclosure.

In the specific embodiments of the present disclosure described above, the components included in the disclosure are expressed in a singular or plural form depending on the specific embodiment presented. However, the singular or plural expressions are selected appropriately for the presented situation for the convenience of explanation. It should be appreciated that the present disclosure is not limited to singular or plural components, but even if a component is expressed in the plural form, it may be composed of the singular form, or even if a component is expressed in the singular form, it may be composed of the plural form.

Meanwhile, although the detailed description of the present disclosure has described specific embodiments, it is obvious that various modifications are possible within the scope of the present disclosure. Therefore, the scope of the present disclosure should not be limited to the described embodiments, but should be determined by the scope of the claims described below as well as the equivalents of the claims.

What is claimed is:

1. A method of providing user plane function (UPF) functionality information in a wireless communication system, the method comprising:
registering, by a first network function, the UPF functionality information including a packet inspection functionality to a network repository function (NRF); and
searching, by a second network function, the NRF for the UPF including the packet inspection functionality,
wherein the registering of the UPF functionality information to the NRF comprises:
registering the UPF functionality information supporting a packet inspection functionality through a service based interface (SBI), and
containing a packet inspection Feature (packet inspection in a UP function, PINU) in the UPF functionality information; and
the searching for the UPF comprises:
transmitting a search request through the SBI, and
containing search parameters including the packet inspection Feature (PINU) in the search request.

2. A method of claim 1,
wherein the registering of the UPF functionality information is performed using Nnrf_NFManagement_Register Request service or Nnrf_NFManagement_Update Request service through the SBI;
wherein the Nnrf_NFManagement_Register Request service or the Nnrf_NFManagement_Update Request service includes supportedPfcpFeatures information indicating UP Function Features; and
wherein the supportedPfcpFeatures information comprises the Packet Inspection Feature (Packet Inspection in the UP function, PINU).

3. A method of claim 1, wherein the searching for the UPF is performed using Nnrf_NFDiscovery_NFDiscover service through the SBI, and the Nnrf_NFDiscovery_NFDiscover service comprises query parameters, and the query parameters comprise the Packet Inspection Feature (Packet Inspection in the UP function, PINU) as UP Function Features.

4. A method of claim 1, wherein the UPF functionality information further comprises the Packet Inspection Feature (Packet Inspection in the UP function, PINU) in UP Function Features.

5. An apparatus for providing User Plane Function (UPF) function information in a wireless communication system, the apparatus comprising:
a transceiver; and
a processor operably connected to the transceiver,
wherein the processor performs control so that a first network function registers UPF functionality information including a packet inspection functionality to a Network Repository Function (NRF), and
performs control so that a second network function searches the NRF for the UPF including the packet inspection functionality; and
wherein the processor registers the UPF functionality information supporting packet inspection functionality through a Service Based Interface (SBI) and contains a packet inspection Feature (Packet Inspection in the UP function, PINU) in the UPF functionality information, to register the UPF functionality information to the NRF, and
transmits a search request through the SBI, and contains a search parameter with the packet inspection Feature (PINU) in the search request, to search for the UPF.

6. The apparatus of claim 5,
wherein the processor is configured to register the UPF functionality information using Nnrf_NFManagement_Register Request service or Nnrf_NFManagement_Update Request service through the SBI;
wherein the Nnrf_NFManagement_Register Request service or the Nnrf_NFManagement_Update Request service includes supportedPfcpFeatures information indicating UP Function Features; and
wherein the supportedPfcpFeatures information includes the packet inspection feature (PINU).

7. The apparatus of claim 5,
wherein the processor is configured to search for the UPF using the Nnrf_NFDiscovery_NFDiscover service through the SBI;
wherein the Nnrf_NFDiscovery_NFDiscover service includes query parameters; and
wherein the query parameters comprise the packet inspection feature (PINU) as UP Function Features.

8. The apparatus of claim 5, wherein the UPF functionality information further comprises the Packet Inspection Feature (PINU) in the UP Function Features.

9. A method of providing User Plane Function (UPF) function information in a wireless communication system, the method comprising:
performing, by a Session Management Function (SMF), an Association Setup procedure with the UPF through an N4 interface;
checking, by the UPF, whether a Packet Inspection Feature (PINU) is contained in the UP Function Features; and
receiving, by the SMF, a response regarding whether the Packet Inspection Feature (PINU) is supported from the UPF.

10. The method of claim 9,
wherein the Association Setup procedure is performed using N4 Packet Forwarding Control Protocol (PFCP);
wherein the Association Setup procedure comprises a process in which an N4 Association Setup Request message and an N4 Association Setup Response message are exchanged between the SMF and the UPF; and
wherein the N4 Association Setup Request message and the N4 Association Setup Response message comprise UP Function Features containing the Packet Inspection Feature (PINU).

11. The method of claim 9, wherein the UP Function Features further comprises the Packet Inspection Feature (PINU).

12. The method of claim 9, wherein the checking comprises:
transmitting, by the SMF, the N4 Association Setup Request message to the UPF; and
responding with the N4 Association Setup Response message containing the UP Function Features supported by the UPF.

13. The method of claim 9, wherein the SMF determines whether to establish a session for the UPF based on whether the UPF supports the Packet Inspection Feature (PINU).

14. The method of claim 9, wherein when support of the Packet Inspection Feature (PINU) is confirmed based on the response received from the UPF, the SMF activates the packet inspection functionality for the UPF.
